(19) United States
(12) Patent Application Publication
(10) Pub. No.: US 2019/0232744 A1
(43) Pub. Date: Aug. 1, 2019

(54) AMPHIBIOUS VEHICLE COMPRISING A HULL THAT INCLUDES MOVEABLE HULL SECTIONS

(71) Applicant: Maritime Applied Physics Corporation, Baltimore, MD (US)

(72) Inventors: Thomas Woodwerth Bein, Gambrills, MD (US); Charles Ernest Engstrom, Pasadena, MD (US)

(21) Appl. No.: 15/882,940

(22) Filed: Jan. 29, 2018

(51) Int. Cl. B60F 3/00

(52) U.S. Cl. CPC B60F 3/0038; B60F 3/0007; B60F 3/0069

(57) ABSTRACT

An amphibious vehicle that includes a hull comprising a plurality of hull sections, a hull positioning device configured to position one of more hull sections from the plurality of hull sections into a plurality of positions, a first propulsion device configured to move the amphibious vehicle when the amphibious vehicle is on land, a second propulsion device configured to move the amphibious vehicle when the amphibious vehicle is in a body of water, and a buoyancy device configured to provide buoyancy for the amphibious vehicle when the amphibious vehicle is in the body of water.

### BACKGROUND

### Field

Various features relate to an amphibious vehicle comprising a hull that includes moveable hull sections.

### Background

An amphibious vehicle is a vehicle that can travel on land or water. FIG. 1 illustrates an example of an amphibious vehicle 100 that includes a hull 102, a first set of wheels 104, a second set of wheels 106 and a boat engine 108. The amphibious vehicle 100 uses the first set of wheels 104 and the second set of wheels 106 to move over land. The amphibious vehicle 100 uses the boat engine 108 to move in water. The boat engine 108 may include a propeller that propels the amphibious vehicle 100. The hull 102 is a single hull that provides buoyancy for the amphibious vehicle 100, allowing the amphibious vehicle 100 to float on water.

As shown in FIG. 1, the first set of wheels 104 and the second set of wheels 106 are located externally of the hull 102, even when the amphibious vehicle 100 is in water. This is problematic because the wheels (104, 106) cause a lot of drag in water, and thus severely limits the speed at which the amphibious vehicle 100 can travel in water. In addition, when the wheels (104, 106) are exposed to water, the water can cause the wheels and/or other components coupled to the wheels to breakdown and/or wear out (e.g., through corrosion) very quickly. For example, the wheels may include a metal rim and/or may be coupled to a metal axle, which when continuously exposed to water, may break down due to the corrosive nature of water. Thus, the amphibious vehicle 100 is prone to break down a lot and has limited functionality.

As such, there is a need for an amphibious vehicle that can travel at high speeds on land and in water, is stable when operating in waves, is very maneuverable on land and in water, and can withstand the rigors of water, sand, wind, dust and mud. Ideally, such an amphibious vehicle may have multiple configurations that allows the amphibious vehicle to operate optimally in different environments, conditions, terrains and/or landscapes.

### SUMMARY

Various features relate to an amphibious vehicle comprising a hull that includes moveable hull sections.

An example provides an amphibious vehicle that includes a hull comprising a plurality of hull sections, a hull positioning device configured to position one of more hull sections from the plurality of hull sections into a plurality of positions, a first propulsion device configured to move the amphibious vehicle when the amphibious vehicle is on land, a second propulsion device configured to move the amphibious vehicle when the amphibious vehicle is in a body of water, and a buoyancy device configured to provide buoyancy for the amphibious vehicle when the amphibious vehicle is in the body of water.

In some implementations, the hull comprising the plurality of hull sections includes a continuous planing surface. In some implementations, the amphibious vehicle further comprises a plurality of wheels coupled to the first propulsion device, where the first propulsion device is configured to power the plurality of wheels and power the second propulsion device. In some implementations, the first propulsion device is configured to power the plurality of wheels and power the second propulsion device simultaneously. In some implementations, the second propulsion device comprises a waterjet. In some implementations, the first propulsion device comprises a motor.

In some implementations, the plurality of hull sections comprises a first hull section, a second hull section, and a third hull section, where the first hull section and the second hull sections are configurable to be coupled to the third hull section.

In some implementations, the amphibious vehicle further includes a first locking device configured to lock the first hull section to the third hull section, and a second locking device configured to lock the second hull section to the third hull section.

In some implementations, the amphibious vehicle further includes a frame structure coupled to the third hull section, wherein the third hull section is fixed to the frame structure. In some implementations, the amphibious vehicle further includes a first seal layer configured to seal a seam between the first hull section and the third hull section, and a second seal layer configured to seal a seam between the second hull section and the third hull section.

In some implementations, the amphibious vehicle includes a frame structure coupled to the buoyancy device. In some implementations, the buoyancy device includes an enclosed volume, a flexible membrane, an inflatable membrane, and/or a rigid volume.

In some implementations, the hull positioning device is configured to rotate the first hull section along a first rotation axis and a second rotation axis. In some implementations, the rotation of the first hull section is driven by a linear actuator. In some implementations, the rotation of the first hull section is driven by a rotary actuator. In some implementations, the hull positioning device is configured to translate the first hull section.

### BRIEF DESCRIPTION OF THE DRAWINGS

Various features, nature and advantages may become apparent from the detailed description set forth below when taken in conjunction with the drawings in which like reference characters identify correspondingly throughout.

FIG. 1 illustrates an amphibious vehicle in a body of water.

FIG. 2 illustrates an angled top view of an amphibious vehicle that includes a hull comprising moveable hull sections.

FIG. 3 illustrates an angled bottom view of an amphibious vehicle that includes a hull comprising moveable hull sections.

FIG. 4 illustrates an angled view of a portion of the hull comprising moveable hull sections, where a locking device is used to lock two neighboring hull sections.

FIG. 5 illustrates a hull moving device for an amphibious vehicle.

FIG. 6 illustrates a side view of a frame for the amphibious vehicle when the amphibious vehicle is in a water mode configuration.

FIG. 7 illustrates a side view of a frame for the amphibious vehicle when the amphibious vehicle is in a land mode configuration.

FIG. 8 illustrates a top view of a frame for the amphibious vehicle.

FIG. 9 illustrates a front view of the amphibious vehicle when the amphibious vehicle is in a water mode configuration.

FIG. 10 illustrates a back view of the amphibious vehicle when the amphibious vehicle is in a water mode configuration.

FIG. 11 illustrates an angled view of the amphibious vehicle when the amphibious vehicle is in an intermediate mode configuration.

FIG. 12 illustrates another angled view of the amphibious vehicle when the amphibious vehicle is in an intermediate mode configuration.

FIG. 13 illustrates a front view of the amphibious vehicle when the amphibious vehicle is in an intermediate mode configuration.

FIG. 14 illustrates a back view of the amphibious vehicle when the amphibious vehicle is in an intermediate mode configuration.

FIG. 15 illustrates an angled view of the amphibious vehicle when the amphibious vehicle is in a land mode configuration.

FIG. 16 illustrates another angled view of the amphibious vehicle when the amphibious vehicle is in a land mode configuration.

FIG. 17 illustrates a front view of the amphibious vehicle when the amphibious vehicle is in a land mode configuration.

FIG. 18 illustrates a rear view of the amphibious vehicle when the amphibious vehicle is in a land mode configuration.

FIG. 19 (which includes FIGS. 19A-19C) illustrates a sequence of an amphibious vehicle changing from a water mode configuration to a land mode configuration.

FIG. 20 (which includes FIGS. 20A-20C) illustrates a sequence of an amphibious vehicle changing from a land mode configuration to a water mode configuration.

FIG. 21 illustrates a flow chart of a method for changing an amphibious vehicle from a water mode configuration to a land mode configuration.

FIG. 22 illustrates a flow chart of a method for changing an amphibious vehicle from a land mode configuration to a water mode configuration.

FIG. 23 illustrates various components of a controller for an amphibious vehicle.

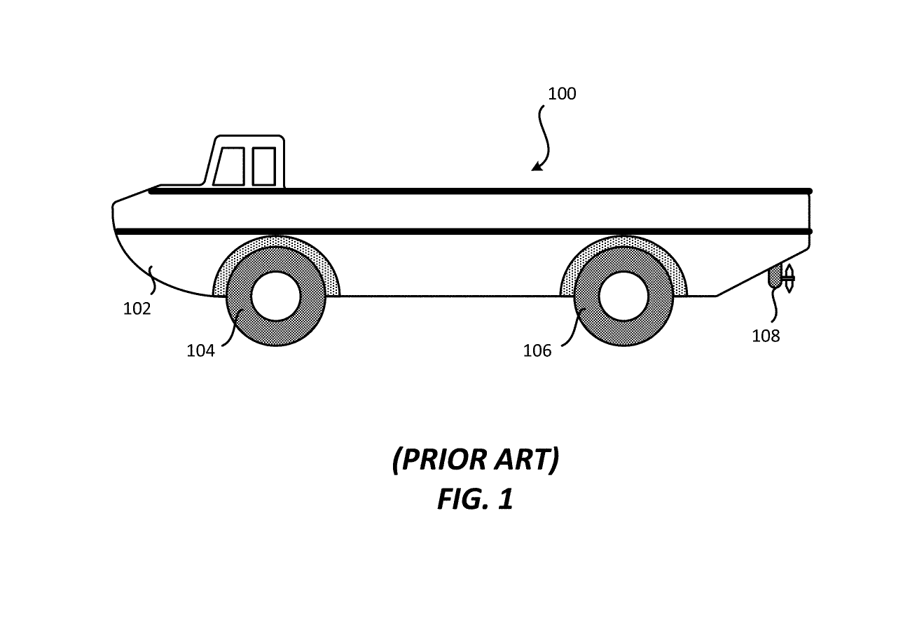

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The present disclosure describes an amphibious vehicle that includes a hull comprising a plurality of hull sections, a hull positioning device configured to position one of more hull sections from the plurality of hull sections into a plurality of positions, a first propulsion device configured to move the amphibious vehicle when the amphibious vehicle is on land, a second propulsion device configured to move the amphibious vehicle when the amphibious vehicle is in a body of water, and a buoyancy device configured to provide buoyancy for the amphibious vehicle when the amphibious vehicle is in the body of water.

### Exemplary Amphibious Vehicle

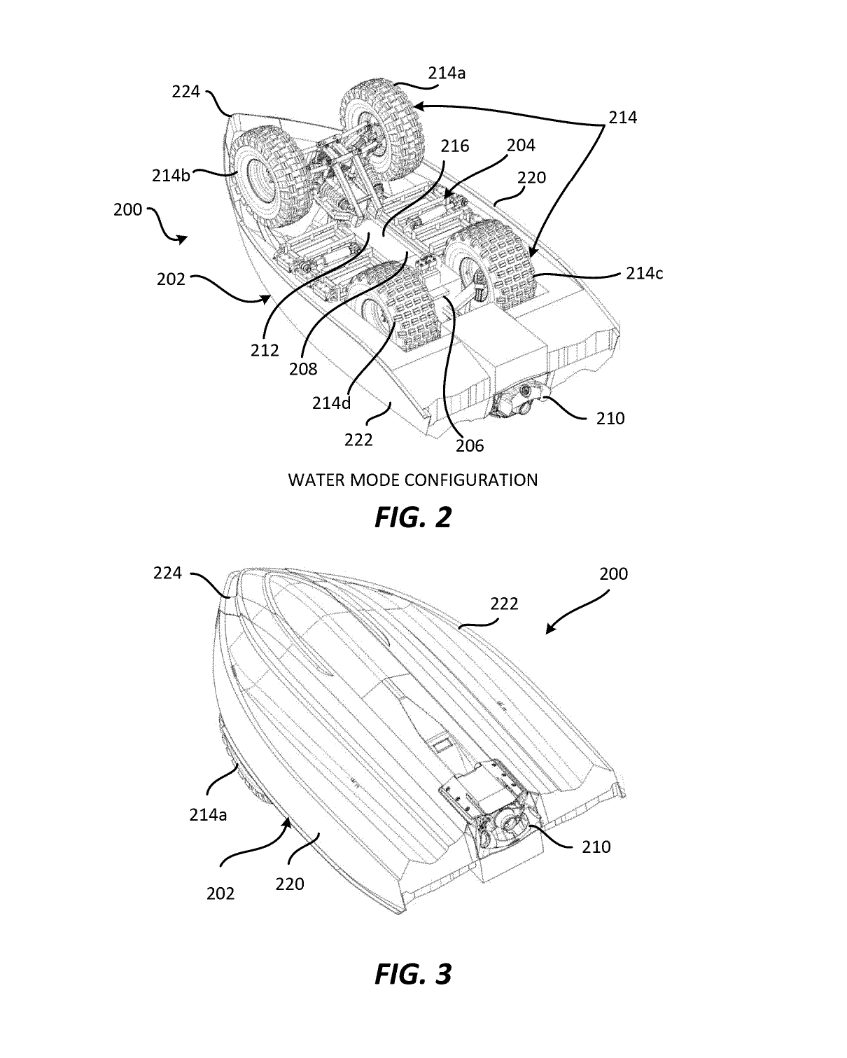

FIG. 2 illustrates a perspective top view of an amphibious vehicle 200 that is capable of operating in a body of water and on land. As will be further described in the disclosure, the amphibious vehicle 200 illustrates an example of an amphibious vehicle that includes deployable waterborne hull sections that provides a continuous planing surface. The amphibious vehicle 200 may be configurable to transition between land and in-water operation modes without requiring human assistance. Moreover, the amphibious vehicle 200 may be configured to remain stable throughout the transition between different modes and/or configurations. The amphibious vehicle 200 can be operated in either a manned configuration or unmanned configuration. The amphibious vehicle 200 is capable of high land speed and high water speed, and is stable when operating in waves and/or in the surf zone. In addition, the devices, mechanisms, and/or systems that position the hull sections are configured so that they are resistant to fouling due to corrosion, dirt, mud, and sand.

As shown in FIG. 2, the amphibious vehicle 200 includes a hull 202, a hull positioning device 204, a frame structure 206, a first propulsion device 208, a second propulsion device 210, a buoyancy device 212, a plurality of wheels 214, and a controller 216. The plurality of wheels 214 may include wheels 214a, 214b, 214c, and 214d. The wheels 214a and 214b may be front wheels, and the wheels 214c and 214d may be back wheels.

The hull 202 is coupled to the hull positioning device 204. The hull positioning device 204 is coupled to the frame structure 206. The plurality of wheels 214 is coupled to the frame structure 206. The first propulsion device 208 and the second propulsion device 210 are coupled to the frame structure 206.

The first propulsion device 208 may be configured to propel the amphibious vehicle 200 when the amphibious vehicle 200 is on a land. Different implementations may use different first propulsion devices. For example, the first propulsion device 208 may include an electric motor and/or a combustion engine. The first propulsion device 208 may be coupled (e.g., directly or indirectly) to the plurality of wheels 214 (e.g., wheels 214b). In some implementations, the first propulsion device 208 drives the plurality of wheels 214, which in turns propels the amphibious vehicle 200.

The second propulsion device 210 may be configured to propel the amphibious vehicle 200 when the amphibious vehicle 200 is in a body of water. Different implementations may use different second propulsion devices. For example, the second propulsion device 210 may include a waterjet and/or an outboard motor. As will be further described below, in some implementations, the first propulsion device 208 may power and drive the second propulsion device 210.

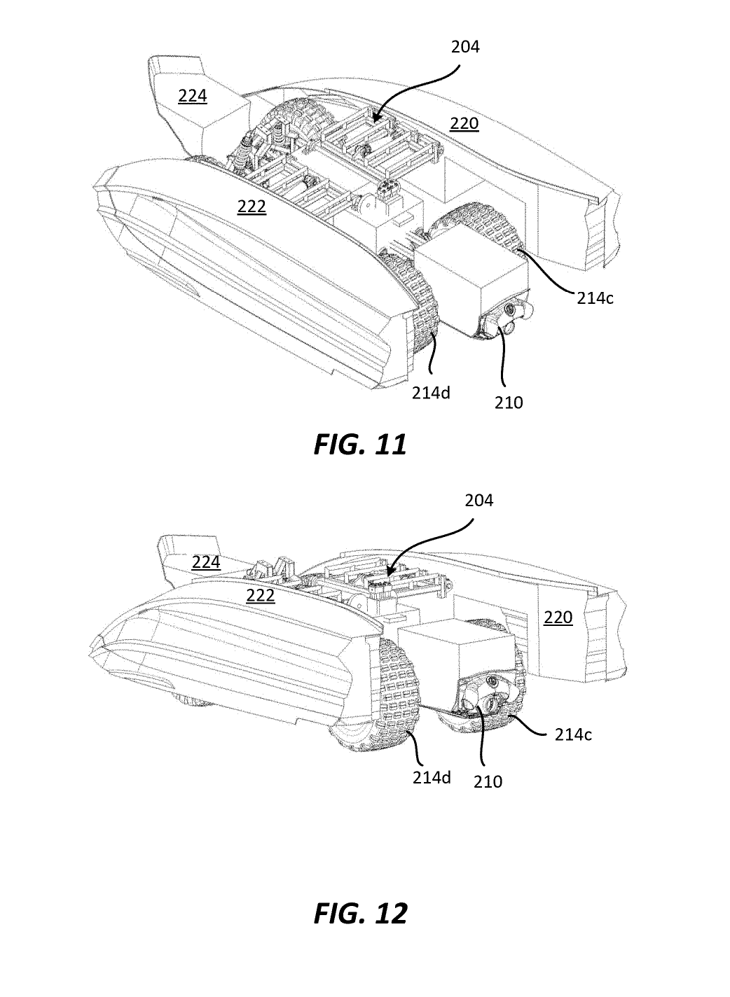

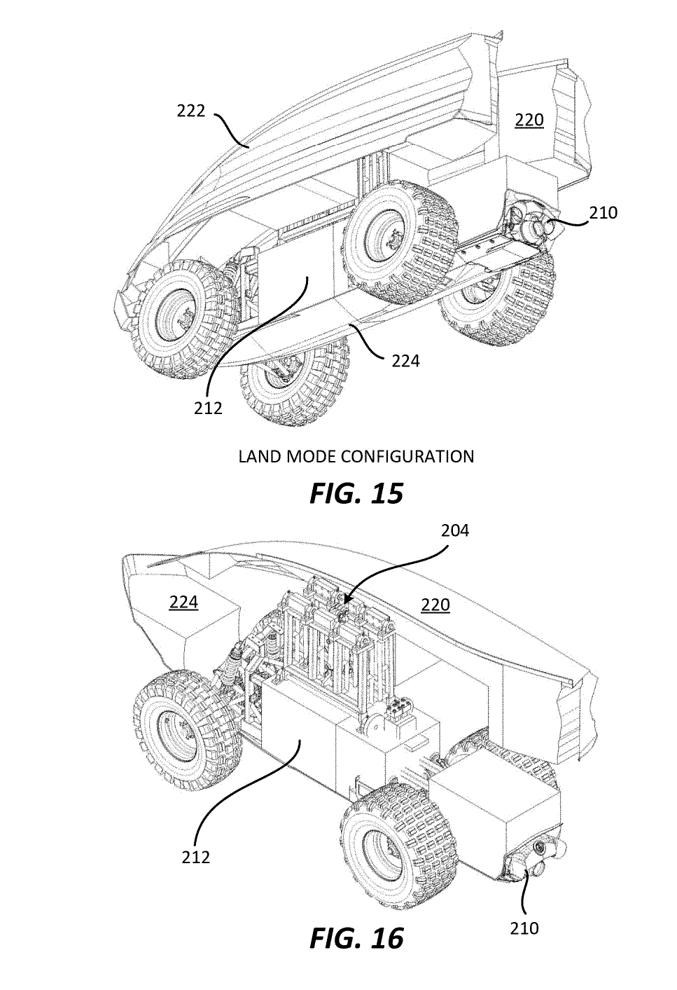

The amphibious vehicle 200 may operate in a water mode configuration (e.g., first configuration) and a land mode configuration (e.g., second configuration). FIGS. 2-3 illustrate the amphibious vehicle 200 in the first configuration (e.g., water mode configuration). An example of the amphibious vehicle 200 in the second configuration (e.g., land mode configuration) is illustrated and described below in at least FIG. 15. It is noted that the amphibious vehicle 200 may operate in other configurations (e.g., third configuration, intermediate configuration). Examples of such other configurations are illustrated and described below in at least FIG. 11.

FIG. 3 illustrates a perspective bottom view of the hull 202 of the amphibious vehicle 200 when the amphibious vehicle 200 is in a water mode configuration (e.g., first configuration). The hull 202 is a watertight body of the amphibious vehicle 200. The hull 202 includes a plurality of hull sections. For example, the hull 202 may include a first hull section 220, a second hull section 222 and a third hull section 224. The first hull section 220 may be a right hull section, the second hull section 222 may be a left hull section and the third hull section 224 may be a center hull section of the amphibious vehicle 200. It is noted that the terms “left” and “right” can refer to a direction or side from the perspective of the front (e.g., bow) of the amphibious vehicle 200 or from the perspective of the rear (e.g., stern) of the amphibious vehicle 200. It is further noted that different implementations of the amphibious vehicle 200 may include different numbers of hull sections, hull sections with different shapes and/or sizes. The hull 202 and the hull sections (e.g., 220, 222, 224) may be made of various materials. In some implementations, the hull 202 and the hull sections (e.g., 220, 222, 224) may include aluminum and/or fiberglass.

FIG. 3 illustrates that the first hull section 220, the second full section 222 and the third hull section 224 are coupled together so as to form a hull that includes a continuous planing surface, even though the hull 202 comprises several separate hull sections. More specifically, the first hull section 220 is coupled to the third hull section 224, and the second hull section 222 is coupled to the third hull section 224. The hull sections are coupled together in such a way as to provide a continuous planing surface for the hull 202, which helps prevent water from entering the amphibious vehicle 200 through the hull 202. In this configuration, the hull 202 is configured to provide hydrostatic lift (e.g., buoyancy) and hydrodynamic lift (e.g., planing) for the amphibious vehicle 200. For example, the hull 202 may be configured to provide support for the amphibious vehicle through buoyancy when the amphibious vehicle 200 is still or operating at low speed, while the hull 202 may be configured to provide support for the amphibious vehicle 200 through planing when the amphibious vehicle 200 is operating at high speed. In both instances, the hull 202 has to be watertight in order to prevent water from entering the amphibious vehicle 200.

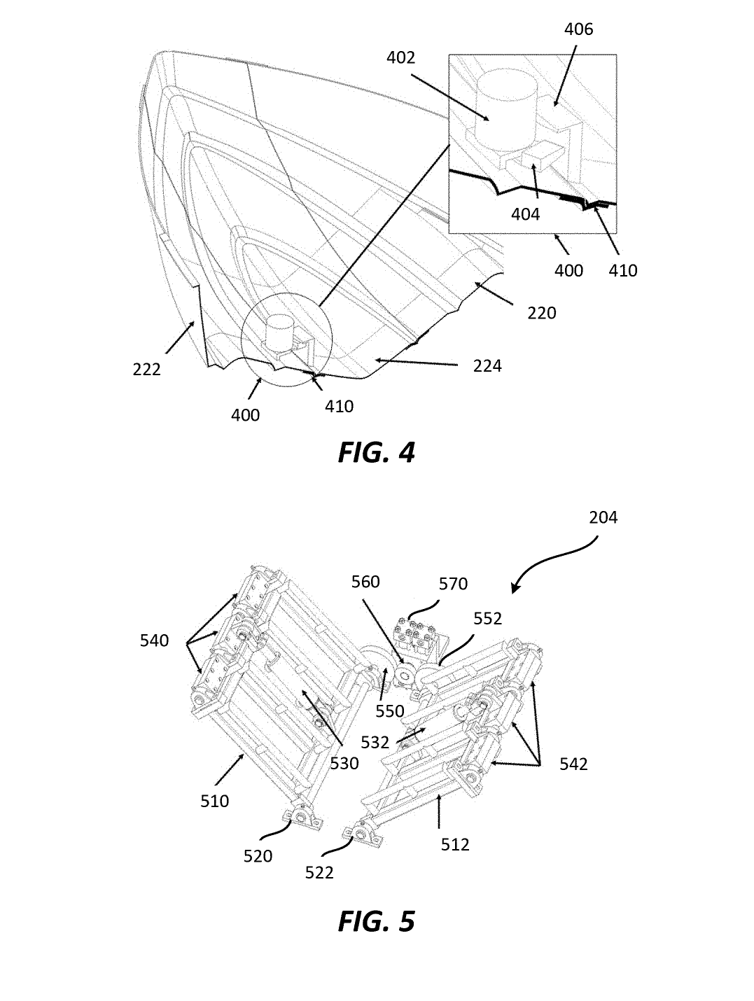

If the hull 202 is not watertight, water can seep in and affect the buoyancy or planing of the amphibious vehicle 200. There are several ways to ensure that the hull 202 is watertight when the hull 202 includes a plurality of separate hull sections. One way is to make sure that the hull positioning device 204 applies enough pressure on the hull sections (e.g., 220, 222, 224) to that there are no gaps between the hull sections. Also, one or more seal layers may be positioned around the seam of the hull sections (e.g., area where hull sections meet or touch) to help ensure there are no gaps between the hull sections. In addition, one or more locking devices may be used to couple and/or lock hull sections together so as there are no gaps between the hull sections when the hull sections are coupled together. Examples of a seal layer and a locking device are further illustrated and described below in at least FIG. 4. In some implementations, a combination of the hull positioning device 204, the seal layers and/or locking devices may help provide a watertight hull 202.

Also, high water speed for the amphibious vehicle 200 requires that the hull 202 ride along on the top of the water surface, commonly referred to as planing, instead of simply pushing the water out of its way, commonly referred to as displacement mode. In order for the hull 202 to plane, sufficient power is applied to the hull 202 to increase the speed in displacement mode to achieve the planing condition. Whereas a flat bottom hull can operate on a plane, it does not meet the objective of the present disclosure to perform well when operating in waves and surf zones. Hull bottoms shaped with a wedge, commonly referred to as deep-vee hulls, and are capable of maintaining high water speed when traversing waves. Numerous studies have been conducted on the effect of the proportions of the hull, the weight that is carried, and the location of the center of gravity on the amount of power required to get on plane. The hull of a vessel that performs well in waves and requires the minimum power to get the hull on plane typically has smooth continuous surfaces. In some implementations, longitudinal features are added to the continuous surface to redirect the water away from the hull 202. Transverse edges are avoided as they create significant drag which dramatically increases the power required to push the hull through the water.

Thus, despite the fact that the hull 202 includes a plurality of separate hull sections, the amphibious vehicle 202 includes a configuration that has a hull that includes a continuous planing surface, which allows the amphibious vehicle 200 to operate at high speeds and be very maneuverable. Different implementations may provide hull sections that are formed and coupled together differently. For example, the hull sections may be cut along a length, along a width, diagonally and/or combinations thereof, of the amphibious vehicle 200. The seams between hull sections may be straight, curved and/or non-linear. For example, the seams between the hull sections may be substantially parallel to a longitudinal axis of the amphibious vehicle 200.

In some implementations, the amphibious vehicle 200 may be able to travel in water at speeds of up to 40 knots (kts) without compromising the hull 202, the hull sections and/or the seals (e.g., seal layer). That is, in some implementations, the amphibious vehicle 200 may travel in water at speeds of up to 40 knots (kts) and have a hull 202 that has a continuous planing surface and/or is watertight despite the hull 202 comprising several hull sections.

### Exemplary Locking Device and Seal Layer

FIG. 4 illustrates a perspective top view of part of the hull 202 of the amphibious vehicle 200. As shown in FIG. 4, the second hull section 222 (e.g., left hull section) is coupled to the third hull section 224 (e.g., center hull section), and the first hull section 220 (e.g., right hull section) is coupled to the third hull section 224.

FIG. 4 illustrates a locking device 400 and a seal layer 410 coupled to the hull 202. The locking device 400 and the seal layer 410 help ensure a watertight seal between hull sections. It is noted that the locking device 400 and the seal layer 410 may be used separately or in combination with each other. In the example of FIG. 4, the locking device 400 and the seal layer 410 are used in combination with each other. The seal layer 410 is coupled (e.g., bonded) to the second hull section 222 and travels along a first seam (e.g., along part of the seam or along the entire seam) between the second hull section 222 (e.g., left hull section) and the third hull section 224 (e.g., center hull section). The seal layer 410 is coupled to the second hull section 222 such that seal layer 410 is located on an external surface of the hull 202. However, the seal layer 410 may be located on an internal surface of the hull 202. In some implementations, the seal layer 410 may be coupled to the third hull section 224. Although not shown, another seal layer may be coupled (e.g., bonded) to the second hull section 222 and may travel along a second seam (e.g., along part of the seam or along the entire seam) between the second hull section 222 (e.g., right hull section) and the third hull section 224 (e.g., center hull section). The seal layer 410 is an example of a means for sealing a seam between two or more hull sections (e.g., 220, 222, 224) of the hull 202. The seal layer 410 may include a flexible material (e.g., rubber) that can follow the contours of the hull sections. The seal layer 410 may be part of the hull sections and be compressed as the hull sections are brought together and coupled to one another, thus providing a watertight seal. Also, the force of the hull 202 moving over the water will provide pressure on the seal layer 410 to provide a watertight seal. In some implementations, the seal layer 410 may include rubber, rubber with fabric, an inflatable seal, and/or hinged seal (e.g., hinged aluminum). In some implementations, the seal layer 410 may include a soft seal layer and a strength layer. However, different seal layers for the hull 202 may use different materials and/or different combinations of materials.

The locking device 400 may be a means for hull locking. The locking device 400 includes a rotary actuator 402, a tab 404 and a latch 406. The latch 406 may include an inclined surface. The tab 404 may also include an inclined surface. The tab 404 is coupled to the rotary actuator 402. In some implementations, the rotary actuator 402 may be coupled to the second hull section 222, and the latch 406 may be coupled to the third hull section 224. The locking device 400 may help couple and lock the second hull section 222 (e.g., left hull section) and the third hull section 224 (e.g., center hull section). The second hull section 222 and the third hull section 224 may be locked together by causing the rotary actuator 402 to turn the tab 404 towards the latch 406. The locking device 400 is located inside of the amphibious vehicle 200. However, in some implementations, the locking device 400 may be located externally of the amphibious vehicle 200. In some implementations, the rotary actuary 402 may be coupled to the third hull section 224 and the latch 406 may be coupled to the second hull section 222.

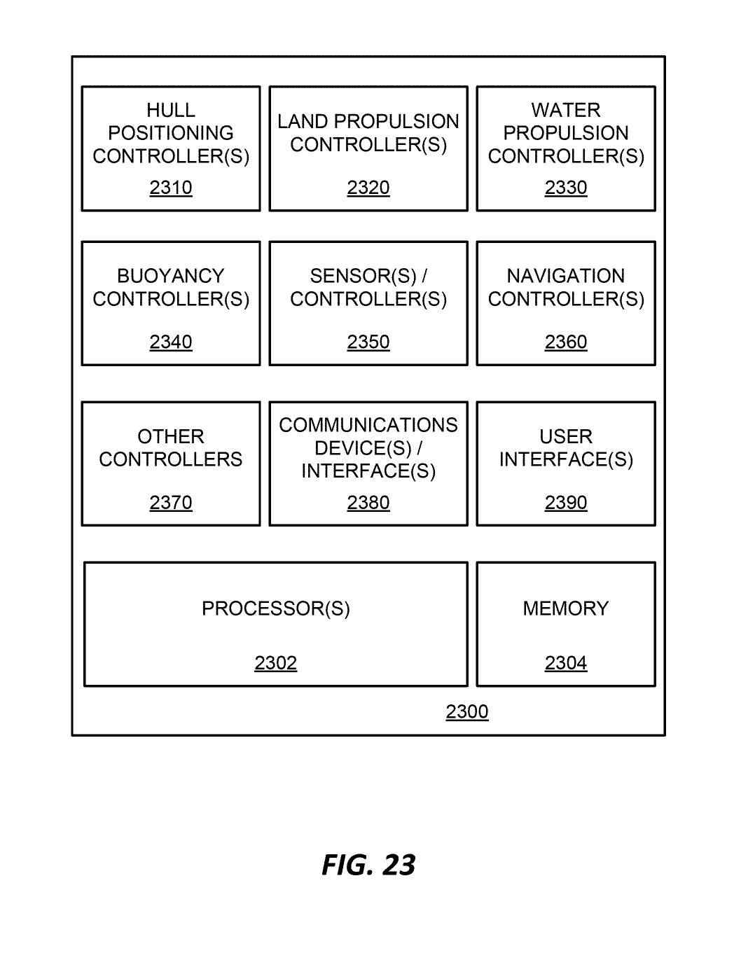

Another locking device (e.g., 400) may also be used to couple and lock the first hull section 220 (e.g., right hull section) to the third hull section 224 (e.g., center hull section). The locking device 400 is an example of one of many different types of locking devices that can be used to couple and lock two or more hull sections. The locking device 400 is an example of a means for hull locking. It is noted that some implementations may include several locking devices between the different hull sections of the hull 202 of the amphibious vehicle 200. The locking device 400 may be controlled and/or operated by the controller 2300, which is illustrated and described further below in at least FIG. 23.

It is noted that different implementations of the hull 202 may include different numbers of hull sections and/or different sizes and shapes for the hull sections. For example, the hull 202 may include the first hull section 220 and the second hull section 222, where these two hull sections are coupled to each other. A locking device 400 may be used to lock the first hull section 220 to the second hull section 222. A seal layer 410 may be located along a seam between the first hull section 220 to the second hull section 222. The seal 410 may be coupled to either or both of the first hull section 220 to the second hull section 222.

As mentioned above, the hull 202 includes hull sections that can be deployed in different positions and/or configurations. In some implementations, these hull sections (e.g., 222, 224) may be positioned by using the hull positioning device 204, as previously mentioned above in FIG. 2. The hull positioning device 204 will now be described in further detail below.

### Exemplary Hull Positioning Device for an Amphibious Vehicle

FIG. 5 illustrates a perspective view of the hull positioning device 204 that can be implemented with the amphibious vehicle 200. The hull positioning device 204 may be coupled to the frame structure 206 and the plurality of hull sections (e.g., first hull section 220, second hull section 222).

As will be further described below, the hull positioning device 204 is configured to translate, rotate one or more hull sections (e.g., first hull section 220, second hull section 222). The hull positioning device 204 may be configured to provide multi-axis rotation of one or more hull sections. For example, the hull positioning device 204 may be configured to rotate the first hull section 220 along a first rotation axis and a second rotation axis. The hull positioning device 204 may be configured to rotate the second hull section 222 along the first rotation axis and the second rotation axis.

The hull positioning device 204 may be a means for hull positioning. The hull positioning device 204 includes a first rotation frame 510, a second rotation frame 512, a plurality of first hinge mounts 520 (e.g., first ball bearing hinge mount), a plurality of second hinge mounts 522 (e.g., second ball bearing hinge mount), a first hydraulic cylinder 530, a second hydraulic cylinder 532, a first mounting block 540, a second mounting block 542, a first gear 550 (e.g., first spur gear), a second gear 552 (e.g., second spur gear), a gear 560 (e.g., third gear) and a rotary actuator 570.

The first plurality of hinge mounts 520 and the second plurality of hinge mounts 522 are configured to be coupled to the frame structure 206. The first rotation frame 510 is coupled to the plurality of first hinge mounts 520. The plurality of first hinge mounts 520 allows the first rotation frame 510 to rotate and/or pivot about the frame structure 206. The second rotation frame 512 is coupled to the plurality of second hinge mounts 522. The plurality of second hinge mounts 522 allows the second rotation frame 512 to rotate and/or pivot about the frame structure 206.

The first rotation frame 510 is coupled to the first mounting block 540. The first hydraulic cylinder 530 is coupled to the first rotation frame 510 and the first mounting block 540. The first mounting block 540 is configured to be coupled to a hull section (e.g., first hull section 220). The first mounting block 540 may pivot and/or rotate about the first rotation frame 510. When the first mounting block 540 is coupled to the first hull section 220, the first hull section 220 may also pivot and/or rotate about the first rotation frame 510. The rotation of the first mounting block 540 and the first hull section 220 may be driven by the first hydraulic cylinder 530. The first hydraulic cylinder 530 may be controlled by a controller (e.g., controller 216, controller 2300).

The second rotation frame 512 is coupled to the second mounting block 542.

The second hydraulic cylinder 532 is coupled to the second rotation frame 512 and the second mounting block 542. The second mounting block 542 is configured to be coupled to a hull section (e.g., second hull section 222). The second mounting block 542 may pivot and/or rotate about the second rotation frame 512. When the second mounting block 542 is coupled to the second hull section 222, the second hull section 222 may also pivot and/or rotate about the second rotation frame 512. The rotation of the second mounting block 542 and the second hull section 222 may be driven by the second hydraulic cylinder 532. The second hydraulic cylinder 532 may be controlled by a controller (e.g., controller 216, controller 2300).

The first rotation frame 510 is coupled to the first gear 550. The first gear 550 is coupled to the gear 560. The second rotation frame 512 is coupled to the second gear 552. The second gear 552 is coupled to the gear 560. The gear 560 is coupled to the rotary actuator 570. The gear 560 may be a third gear that is configured as a pinion. The rotation of the first rotation frame 510 and the second rotation frame 512 may be driven by the rotatory actuator 570. The rotatory actuator 570 turns the gear 560, which rotates the first gear 550 and the second gear 560, which in turns rotates the first rotation frame 510 and the second rotation frame 512. The rotatory actuator 570 may be controlled and/or operated by the controller 2300, which is illustrated and described further below in at least FIG. 23.

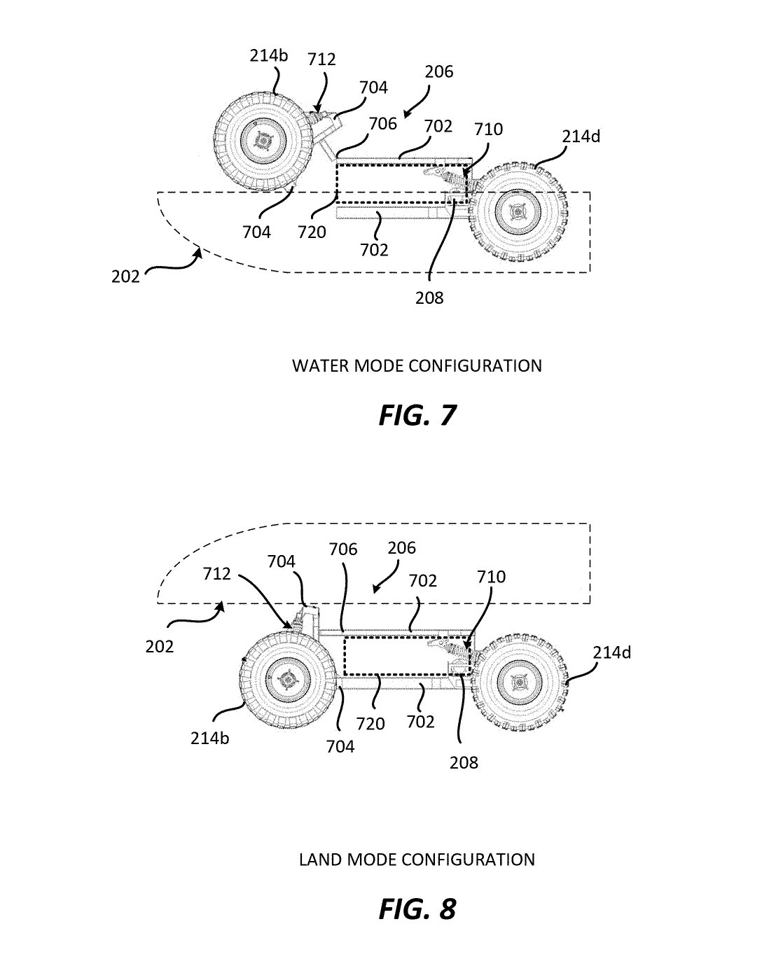

The hull positioning device 204 provides a compact and efficient mechanism for positioning hull sections of the amphibious vehicle 200. Moreover, the hull positioning device 204 provides a device that minimizes weight while also being structurally strong enough to support the weight of the hull sections. The hull positioning device 204 enables the amphibious vehicle 200 to have different configurations. Examples of different configurations for the amphibious vehicle 200 are illustrated and described below in at least FIGS. 7-18. Different configurations of the amphibious vehicle 200 may use different propulsion devices to propel the amphibious vehicle 200. These different propulsion devices will now be described below.

### Exemplary Propulsion Devices for an Amphibious Vehicle

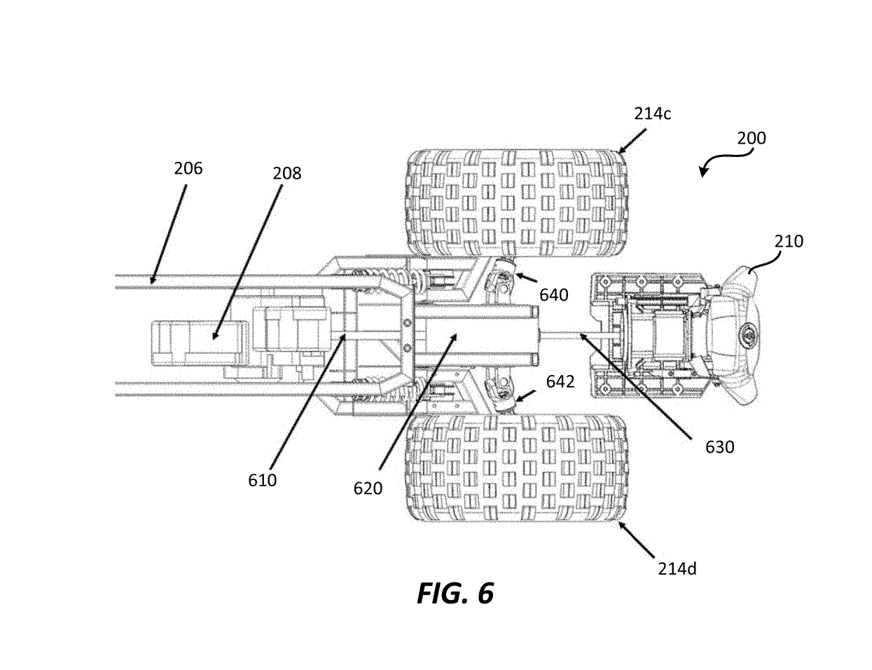

As mentioned above, the amphibious device 200 includes several propulsion devices that are used to propel the amphibious vehicle 200 on land and in a body of water. FIG. 6 illustrates a top view of two propulsion devices that may be implemented with the amphibious vehicle 200. For purpose of clarity, FIG. 6 does not necessarily show all components of the amphibious vehicle 200.

The amphibious vehicle 200 include the frame structure 206, the first propulsion device 208, the second propulsion device 210, an input shaft 610, a transfer case 620, an output shaft 630, a first half-shaft 640 and a second half-shaft 642. In some implementations, a half-shaft may be a drive shaft that includes a universal joint. Thus, for example, the first half-shaft 640 may include a first drive shaft and a first universal joint, and the second half-shaft 642 may include a second drive shaft and a second universal joint.

The first propulsion device 208 is configured to propel the amphibious vehicle 200. The first propulsion device 208 may include an electric motor and/or combustion engine. However, different implementations may use different types of propulsion devices. The first propulsion device 208 is coupled to the input shaft 610. The input shaft 610 is coupled to the transfer case 620. The transfer case 620 is coupled to the output shaft 630, the first half-shaft 640 and the second half-shaft 642.

The first propulsion device 208 drives and powers the input shaft 610. The power from the input shaft 610 is then transferred to the transfer case 620. The transfer case 620 is configured to transfer the power from the first propulsion device 208 and the input shaft 610 to the output shaft 630, the first half-shaft 640 and/or the second half-shaft 642. Different implementations may use different transfer cases.

The transfer case 620 may use gear driven mechanism to provide the power transfer or may use chain driven mechanism to provide the power transfer. The transfer case 620 may include a Manual Shift On-the-Fly (MSOF) transfer case and/or an Electronic Shift On-the-Fly (ESOF) transfer case.

In some implementations, the transfer case 620 may receive power from the first propulsion device 208 and the input shaft 610 and sends the power to the first half-shaft 640 and/or the second half-shaft 642, which then transfer the power to the wheels (e.g., 214c, 214d) of the amphibious vehicle 200. This transfer of power may happen when the amphibious vehicle 200 is configured to operate on land.

In some implementations, the transfer case 620 may receive power from the first propulsion device 208 and the input shaft 610 and sends the power to the output shaft 630, which then transfers the power to the second propulsion device 210 of the amphibious vehicle 200. This transfer of power may happen when the amphibious vehicle 200 is configured to operate in a body of water.

In some implementations, the transfer case 620 may receive power from the first propulsion device 208 and the input shaft 610 and sends the power to both the output shaft 630 and the half-shafts (e.g., 640, 642), which then transfers the power to the second propulsion device 210 of the amphibious vehicle 200. This transfer of power may happen when the amphibious vehicle 200 is configured to operate in a shallow body of water. In such an instance, the amphibious vehicle 200 may be in a body of water but the body of water is shallow enough for the wheels 214 to touch land and/or ground.

It is noted that the power to the first propulsion device 208 may be provided by one or more energy sources such as a battery, a battery storage, and/or a fuel tank. These energy sources may be stored in various locations of the amphibious vehicle 200. Examples of where these energy sources may be located are further illustrated and described below in at least FIGS. 7 and 8.

In the example of FIG. 6, the first propulsion device 208 is configured to operate as the main or primary propulsion device for the amphibious vehicle 200. However, in some implementations, there may be multiple propulsion devices that may be able to operate separately, independently, simultaneously and/or in combination with each other. For example, the second propulsion device 210 may be able to operate by using another propulsion device (e.g., second motor, second combustion engine) that is different than the first propulsion device 208 (e.g., first motor, first combustion engine). In another example, the second propulsion device 210 may include an internal propulsion device (e.g., internal motor, internal engine) that can drive the second propulsion device 210. The second propulsion device 210 may be coupled to one or more energy sources (e.g., battery, fuel tank).

FIG. 6 illustrates that the first propulsion device 208 drives the rear wheels (e.g., 214c, 214d) of the amphibious vehicle 200. In some implementations, the first propulsion device 208 may drive the front wheels (e.g., 214a, 214b) of the amphibious vehicle 200. In such instances, another set of half-shafts may be coupled to the front wheels of the amphibious vehicle 200. In some implementations, the front wheels may be powered and/or driven by another propulsion device, another input shaft, another transfer case, and/or another half-shafts. In some implementations, all the wheels may be powered by one or more propulsion devices, which would make the amphibious vehicle 200 an all-wheel drive (e.g., 4 Wheel Drive) vehicle. Different implementations may use different combinations, and/or arrangements of the propulsion device, input shaft(s), transfer case(s), output shaft(s) and/or half-shaft(s). Thus, FIG. 6 is merely an example of a powertrain configuration for the amphibious vehicle 200.

### Exemplary Configurations of an Amphibious Vehicle

FIGS. 7 and 8 illustrate various configurations of the amphibious vehicle 200. For the purpose of clarity, FIGS. 7 and 8 do show all the components of the amphibious vehicle 200.

FIG. 7 illustrates a side view of the amphibious vehicle 200 in a water mode configuration. In particular, FIG. 7 illustrates the frame structure 206 includes a first frame 702, a second frame 704, an axis point 706, a first suspension system 710, and a second suspension system 712. The first suspension system 710 and/or the second suspension system 712 may include an articulating suspension system.

The first frame 702 and the second frame 704 may be sub-frames of the frame structure 206. These sub-frames may be coupled to a primary frame of the frame structure 206. The first frame 702 may be moved (e.g., raised, lowered) relative to the primary frame of the frame structure 206 by using one or more actuators. Similarly, the second frame 704 may be moved (e.g., raised, lowered) relative to the primary frame of the frame structure 206 by using one or more actuators.

The first frame 702 includes one or more structure components that provides structural support for the amphibious vehicle 200. The second 704 includes one or more structure components that provides structural support for the amphibious vehicle 200. The first frame 702 is coupled to rear wheels (e.g., 214c, 214d) and the first suspension system 710. The first suspension system 710 is coupled to the rear wheels. The second frame 704 is coupled to front wheels (e.g., 214a, 214b) and the second suspension system 712. The second suspension system 712 is coupled to the front wheels. The axis point 706 may include one or more hinges that allows the second frame 704 to rotate relative to the first frame 702, or vice versa.

The second frame 704 has been raised, relative to the first frame 702, which in turns raises the front wheels (e.g., 214a, 214b) and the second suspension system 712. In some implementations, the front wheels are raised to allow the hull 202 to close and form a continuous planning surface. In some implementations, raising the front wheels allows for a more compact hull 202 and a more compact amphibious vehicle 200. An actuator may be used to rotate, raise and lower the second frame 704. In some implementations, raising the front wheels may be optional. This may be the case when the hull 202 is sufficiently large enough to accommodate the front wheels.

FIG. 7 also illustrates a region 720 of the amphibious vehicle that can accommodate and/or store various components of the amphibious vehicle 200. The region 720 may be a storage compartment (e.g., watertight storage compartment) that can house and store components. The region 720 may be coupled to the frame structure 206. The region 720 may house and store propulsion devices (e.g., first propulsion device 208), energy storage (e.g., battery, fuel tank), sensors (e.g., radar, sonar, lidar, Global Positioning System (GPS)), weapons, electronic components, electronic devices, structures, components, objects, elements and/or the controller 2300. It is noted that any of the above items may be stored in different locations and/or in separate locations. For example, some of the components may be stored in the first hull section 220 and/or the second hull section 222. Also, the size and shape of the region 720 is merely exemplary. As such, the region 720 may occupy and/or represent other spaces in and/or around the amphibious vehicle 200. In some implementations, the region 720 may include a plurality of spaces.

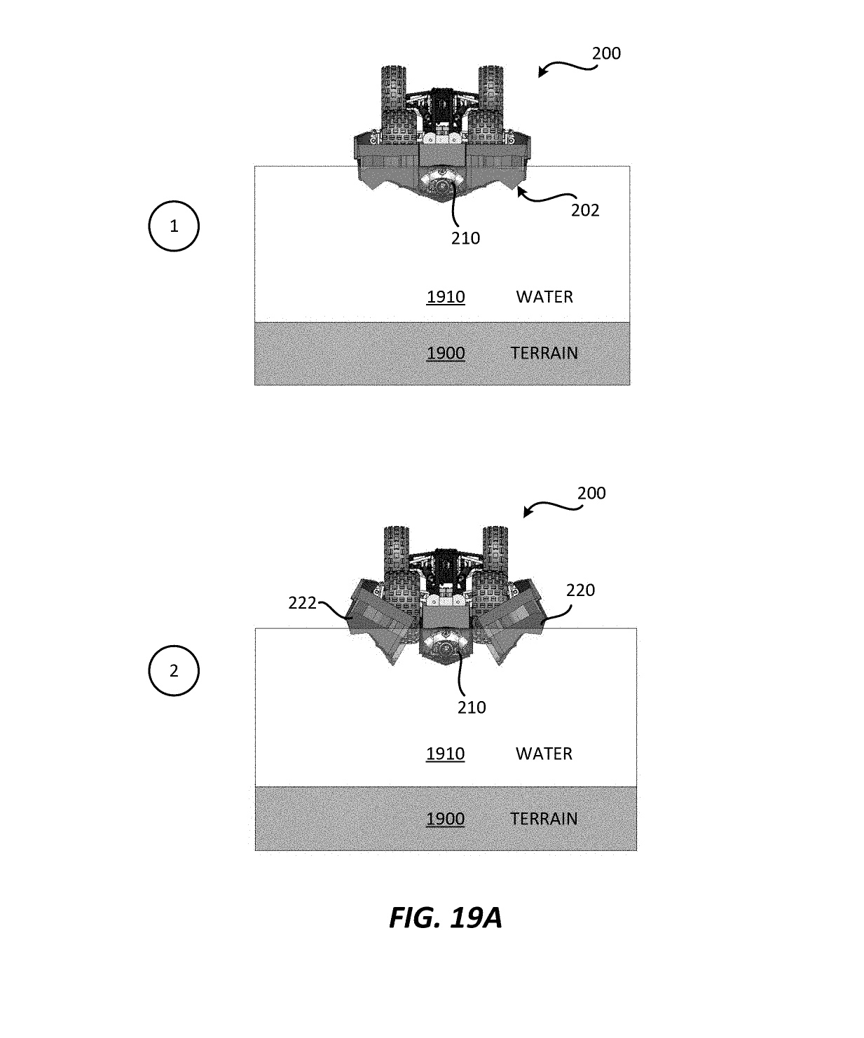

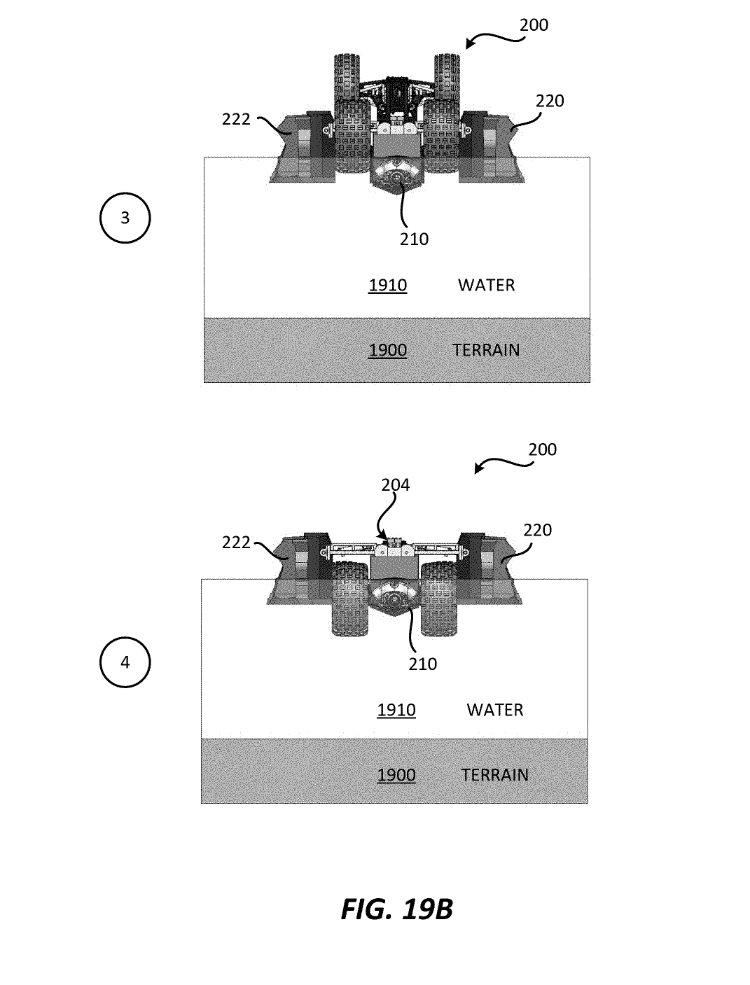

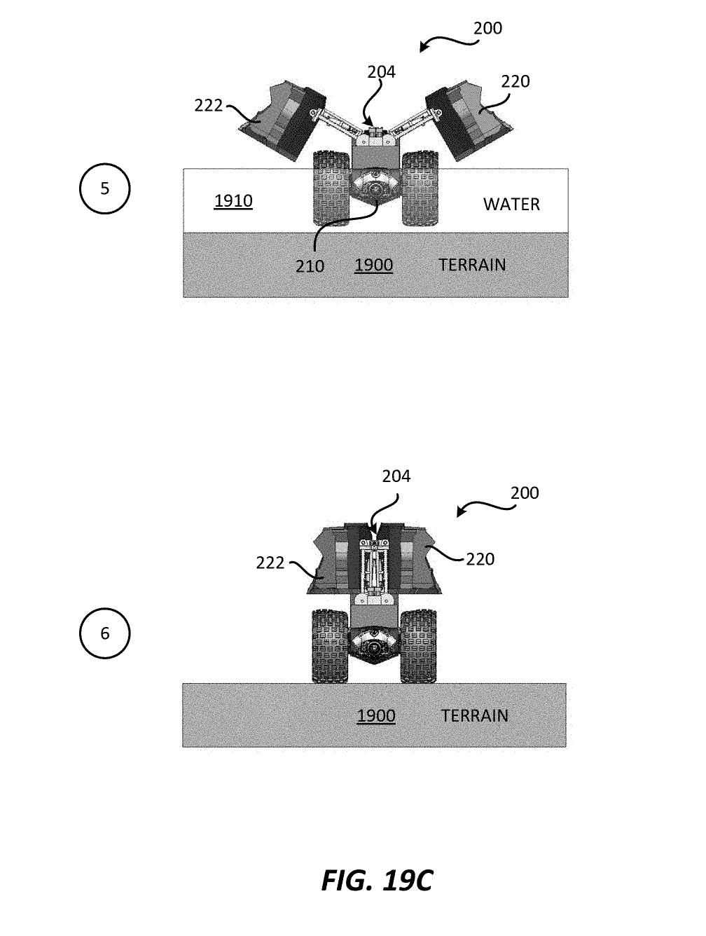

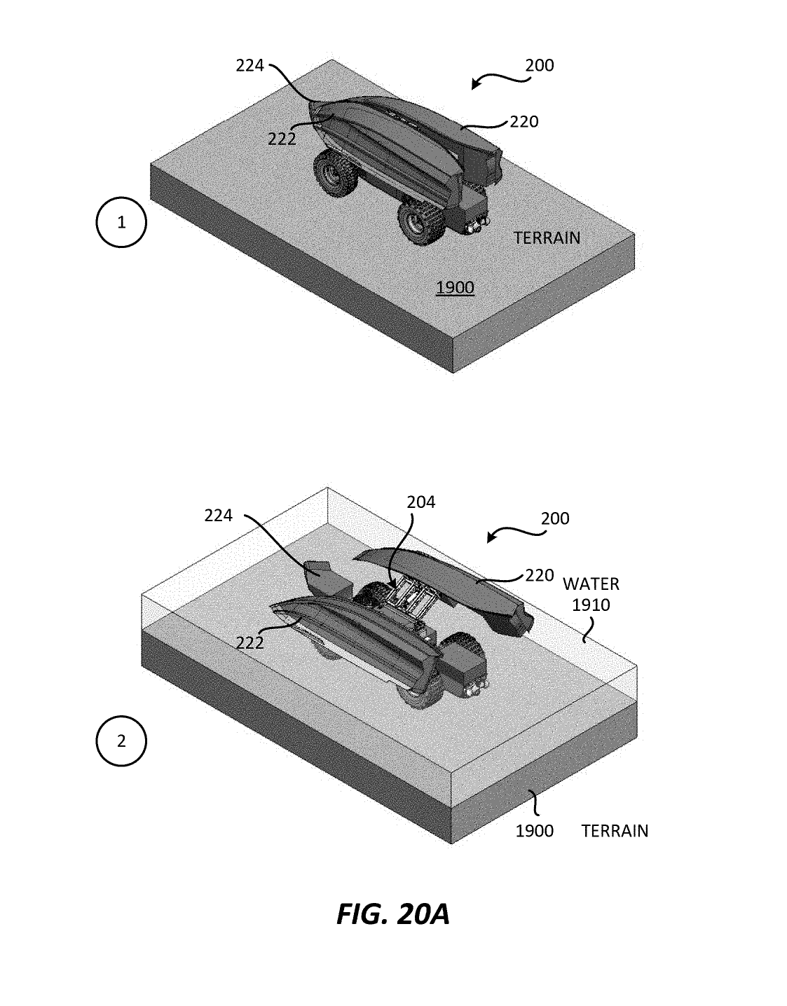

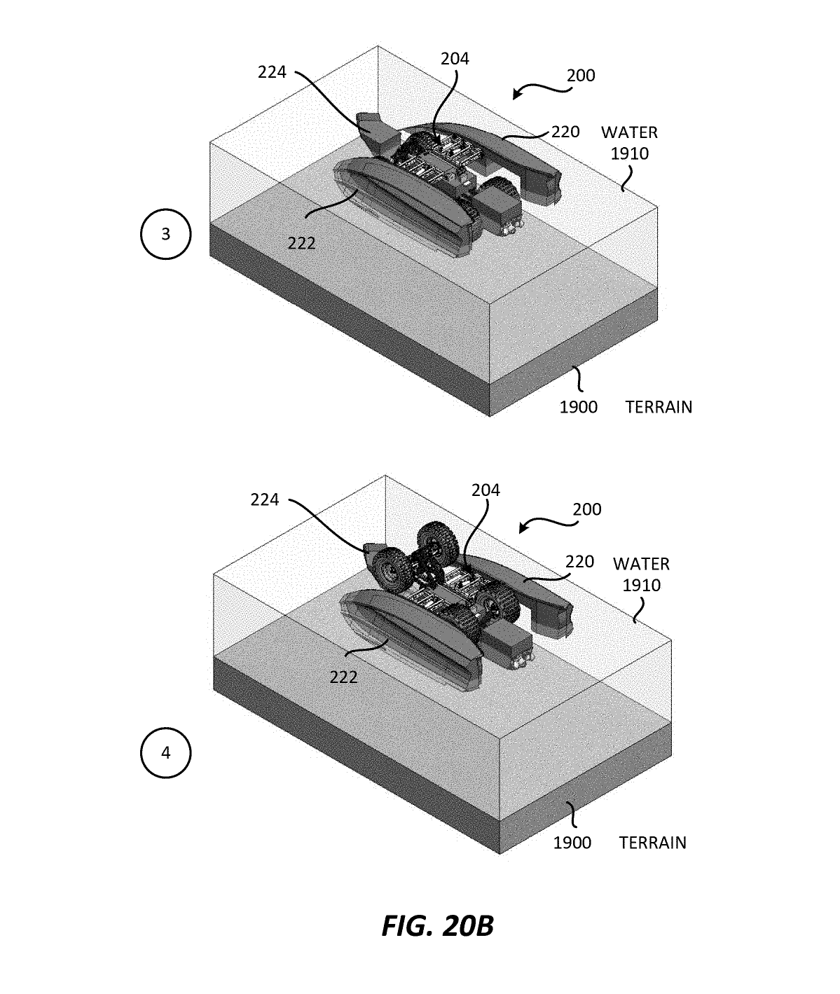

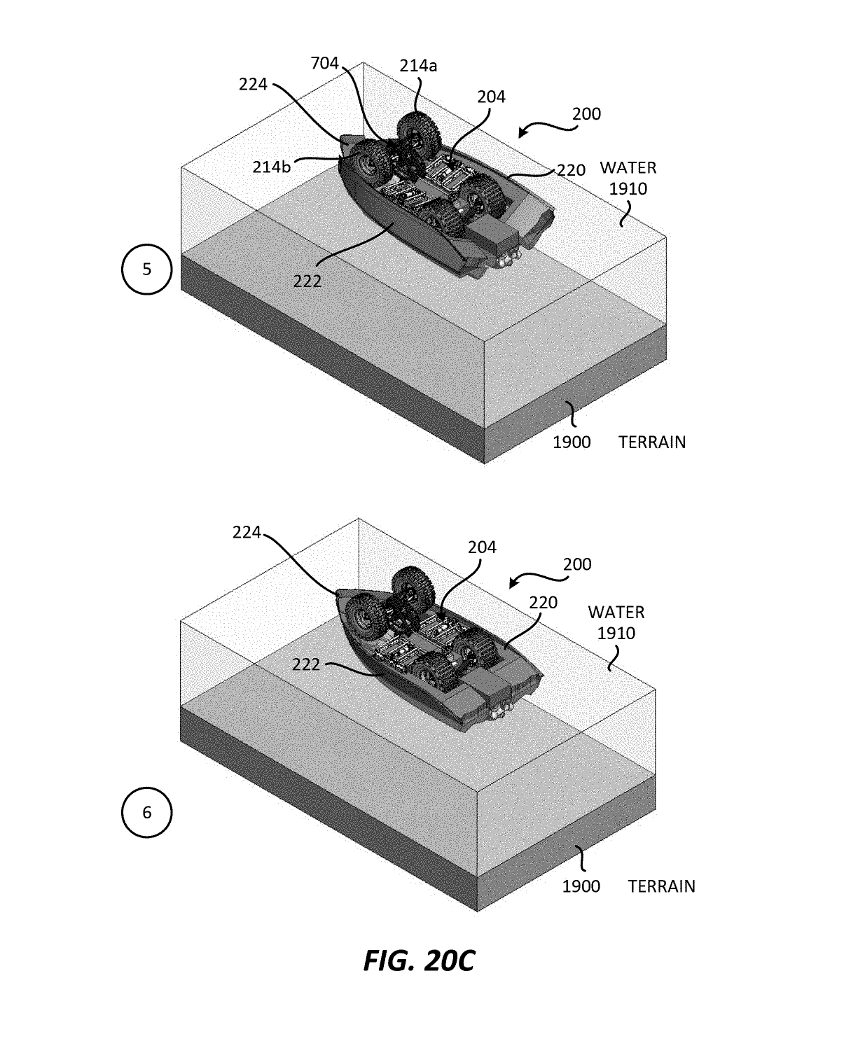

The buoyancy device 212 may be stored in the region 720. In some implementations, when the region 720 is a storage compartment, the region 720 may be configured as the buoyancy device 212. The buoyancy device 212 may be rigid and/or flexible. In some implementations, the buoyancy device 212 may include an inflatable device and/or an inflatable membrane. In some implementations, the buoyancy device 212 may include several buoyancy devices that are located in different locations of the amphibious vehicle 200. As mentioned above, the buoyancy device 212 is configured to provide buoyancy for the amphibious vehicle 200 when the amphibious vehicle is transitioning from a water mode configuration to a land mode configuration, and vice versa. Examples of such transitions are illustrated and described below in FIGS. 19A-19C and FIGS. 20A-20C below.

FIG. 8 illustrates a side view of the amphibious vehicle 200 in a land mode configuration. In the land mode configuration, the hull 202 has been separated in different hull sections and has been positioned to a different location (e.g., at least partially above the frame structure 208). This configuration helps ensure that part of the hull 202 is not damaged by rocks on the terrain while the amphibious vehicle 200 is operating on land. FIG. 8 also illustrates that the front wheels (e.g., 214a, 214b) are no longer raised. However, it is noted that in some implementations, the front wheels may be raised when the amphibious vehicle 200 is in a land mode configuration.

Having mentioned various configurations of the amphibious vehicle 200, various configurations of the amphibious vehicle 200 will now be illustrated and described below in further details.

### Exemplary Water Mode Configuration of an Amphibious Vehicle

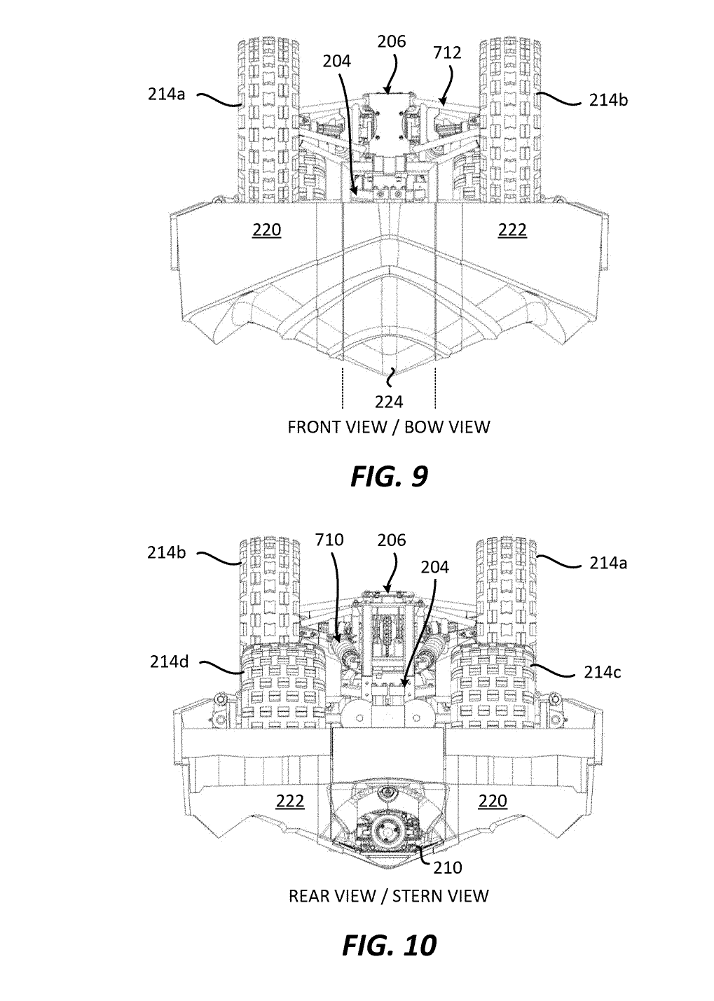

FIG. 9 illustrates a front view of the amphibious vehicle 200 in a water mode configuration (e.g., first configuration). The amphibious vehicle 200 includes the hull 202, the wheels 214a and 214b, the hull positioning device 204, the frame structure 206, and the second suspension system 712.

The hull 202 includes the first hull section 220, the second hull section 222 and the third hull section 224. The first configuration, the first hull section 220, the second hull section 222 and the third hull section 224 are coupled together such that the first hull section 220, the second hull section 222 and the third hull section 224 form a watertight hull 202 that includes a continuous planing surface. The hull sections may be coupled and locked together by the hull positioning device 204. In some implementations, one or more locking device(s) 400 may be used to couple and lock the hull sections of the hull 202. The locking device(s) 400 may be used in addition to the hull positioning device 204 to lock the hull sections together.

The hull positioning device 204 is coupled to the frame structure 206. The frame structure 206 is coupled to the second suspension system 712 and the front wheels (e.g., 214a, 214b).

FIG. 10 illustrates a rear view of the amphibious vehicle 200 in a water mode configuration (e.g., first configuration). As shown in FIG. 10, the amphibious vehicle 200 includes the second propulsion device 210. The second propulsion device 210 is coupled to the frame structure 206. The frame structure 206 is coupled to the first suspension system 710 and the wheels (e.g., 214c, 214d).

### Exemplary Transition Configuration of an Amphibious Vehicle

FIGS. 11 and 12 illustrate perspective views of the amphibious vehicle 200 in a transition configuration (e.g., third configuration). In the configuration shown in FIGS. 11 and 12, the hull sections of the hull 202 are separated. In the transition configuration, the amphibious vehicle 200 may be in a body of water. In the transition configuration, the first hull section 220 and the second hull section 222 have been positioned by the hull positioning device 204 to be positioned laterally (e.g., by the side) of the wheels (e.g., 214a, 214b, 214c, 214d). The first rotation frame 510 and the second rotation frame 512 are located such that they face away from each other. In some implementations, the first rotation frame 510 and the second rotation frame 512 may be substantially parallel to a surface of a body of water (when the water is body of body is still). The first hydraulic cylinder 530 and the second hydraulic cylinder 532 are in a retracted position. However, different implementations may have the hydraulic cylinders in different positions and/or configurations.

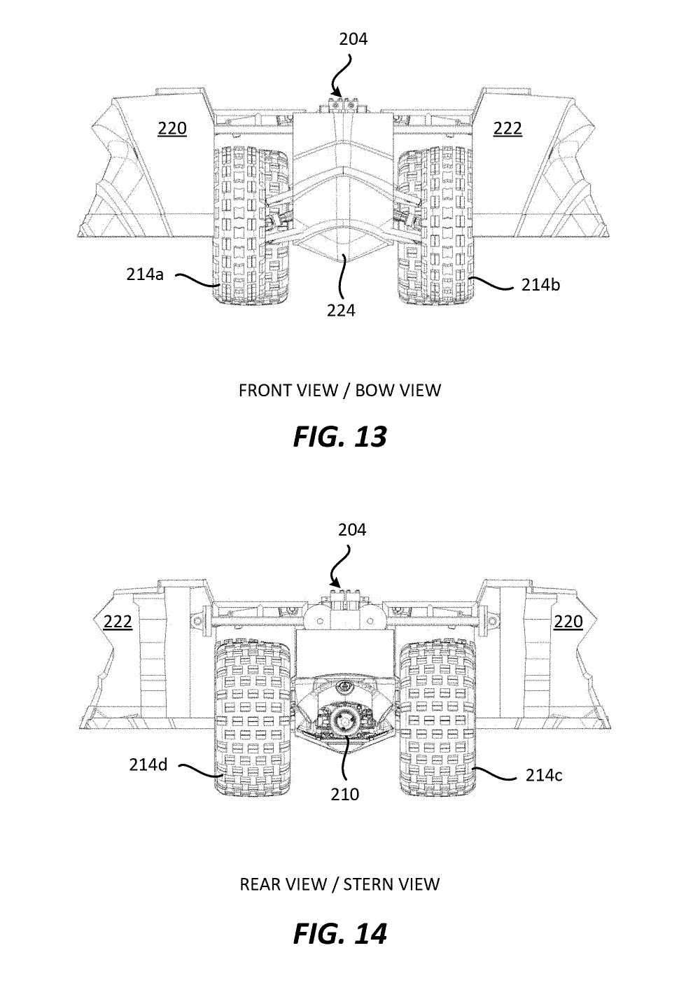

FIG. 13 illustrates a front view of the amphibious vehicle 200 in a transition configuration (e.g., third configuration), while FIG. 14 illustrates a read view of the amphibious vehicle 200 in a transition configuration (e.g., third configuration). In this configuration, the first hull section 220 and the second hull section 222 have been positioned such that they are no longer coupled (e.g., touching) the third hull section 224. The first hull section 220 and the second hull section 222 are positioned laterally to the wheels (e.g., 214a, 214b, 214c, 214d). All of the first hull section 220 and the second hull section 222 are located level to the wheels or at a height that is higher than the wheels. Thus, no portion of the first hulls section 220 and no portion of the second hull section 222 are located below the wheels (e.g., 214a, 214b, 214c, 214d).

In this configuration, the hull 202 may no longer provides enough buoyancy for the amphibious vehicle 200. In such instance, the buoyancy device 212 may provide the necessary buoyancy support so that the amphibious vehicle 200 does not sink. Moreover, moving the hull sections may shift the weight and/or center of gravity of the amphibious vehicle 200, which can cause the amphibious vehicle 200 to tilt, flip and/or tip over. Thus, in some implementations, the buoyancy device 212 helps prevent the amphibious vehicle from tilting, flipping and/or tipping over in the body of water.

### Exemplary Land Mode Configuration of an Amphibious Vehicle

FIGS. 15 and 16 illustrate perspective views of the amphibious vehicle 200 in a land mode configuration (e.g., second configuration). In the configuration shown in FIGS. 15 and 16, the hull sections of the hull 202 are separated. In the land mode configuration, the amphibious vehicle 200 may be in a body of water, but the wheels are touching land. The term land may include ground, terrain, pavement, rocks, grass, dirt, ice, snow and/or any non-liquid surface. In the land mode configuration, the first hull section 220 and the second hull section 222 have been positioned by the hull positioning device 204 to be positioned vertically (e.g., above) to the wheels (e.g., 214a, 214b, 214c, 214d). In this example, the wheels are above land and the hull sections are above the wheels and land. The first rotation frame 510 and the second rotation frame 512 are located such that they face away from the wheels (e.g., 214a, 214b, 214c, 214d) and/or the frame structure 206. In some implementations, the first rotation frame 510 and the second rotation frame 512 may be substantially perpendicular to a surface of a body of water (when the water is body of body is still) and/or land. The first hydraulic cylinder 530 and the second hydraulic cylinder 532 are in an extended position. However, different implementations may have the hydraulic cylinders in different positions and/or configurations.

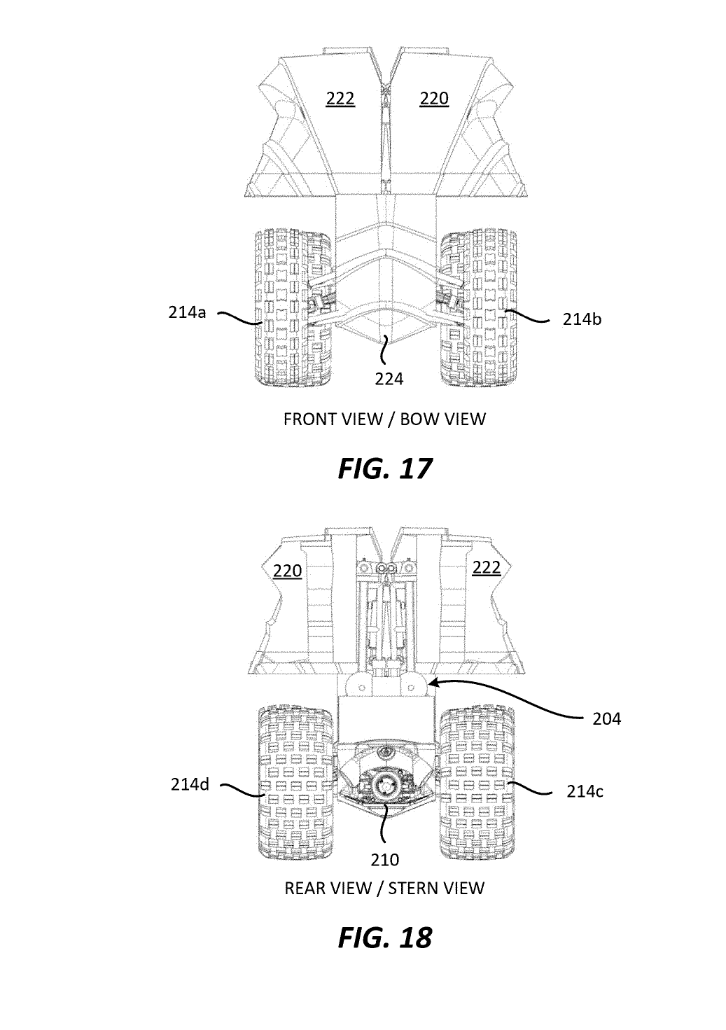

FIG. 17 illustrates a front view of the amphibious vehicle 200 in a land mode configuration (e.g., second configuration), while FIG. 18 illustrates a rear view of the amphibious vehicle 200 in a land mode configuration (e.g., second configuration). In this configuration, the first hull section 220 and the second hull section 222 have been positioned such that they are no longer coupled (e.g., touching) to the third hull section 224. The first hull section 220 and the second hull section 222 are positioned vertically above the wheels (e.g., 214a, 214b, 214c, 214d). All of the first hull section 220 and the second hull section 222 are located level to the wheels or at a height that is higher than the wheels. Thus, no portion of the first hulls section 220 and no portion of the second hull section 222 are located below the wheels (e.g., 214a, 214b, 214c, 214d).

Exemplary Sequence of an Amphibious Vehicle Transitioning from a Water Mode Configuration to a Land Mode Configuration

FIG. 19 (which includes FIGS. 19A-19C) illustrates an exemplary sequence of an amphibious vehicle transitioning from a water mode configuration to a land mode configuration. In some implementations, the sequence of FIGS. 19A-19C illustrates the amphibious vehicle 200 of FIG. 2.

It is noted that the sequence of FIGS. 19A-19C may combine one or more stages in order to simplify and/or clarify the sequence shown in FIGS. 19A-19C. In some implementations, the order of the sequence of the operation may be changed or modified. Additional operations may also be added to the sequence.

Stage 1, as show in FIG. 19A, illustrates a state when the amphibious vehicle 200 in a body of water 1910. The body of water 1910 is located over a terrain 1900. The terrain 1900 is an example of land. The amphibious vehicle 200 is in a water mode configuration. In the water mode configuration, the hull sections (e.g., first hull section 220, the second hull section 222, the third hull section 224) are coupled together and form a hull 202 that includes a continuous planning surface. In some implementations, the hull sections may be coupled and locked together through the hull positioning device 204 and/or the locking device 400. The front wheels (e.g., 214a, 214b) are raised. In this configuration, the amphibious vehicle 200 is propelled through the second propulsion device 210.

Stage 2 illustrates a state after the locking device 400 has been unlocked and the hull sections have been decoupled. The first hull section 220 and the second hull section 222 have been rotated away and translated away from the center of the amphibious vehicle 200. For example, the first hull section 220 and the second hull section 222 have been rotated away and translated away from the third hull section 224 (e.g., center hull section). The hull positioning device 204 may be used to rotate and move the first hull section 220 and the second hull section 222. In some implementations, the third hull section 224 is a fixed hull section. In other words, in some implementations, the third hull section 224 does not move relative to the frame structure 206. In some implementations, the locking device 400 and/or the hull positioning device 204 may be operated and/or controlled by the controller 2300.

It is noted that when the hull 202 is separated into separate hull sections, the hull 202 no longer provides the same level of buoyancy as when the hull sections are coupled together, as shown in stage 1. To help prevent the amphibious device 200 from sinking in the body of the water 1910, the amphibious vehicle 200 may include one or more buoyancy devices 212 to help provide buoyancy for the amphibious vehicle 200. The buoyancy device 212 helps provides stability for the amphibious vehicle 200. The buoyancy device 212 may be a fixed storage compartment, a flexible storage compartment that can be inflated, or combinations thereof. The controller 2300 may be operated and/or controlled by the controller 2300.

Stage 3, as show in FIG. 19B, illustrates a state when the first hull section 220 and the second hull section 222 have been deployed to the point the first hull section 220 and the second hull section 222 are located completely lateral to the wheels (e.g., 214a, 214b, 214c, 214d). The first hull section 220 and the second hull section 222 may be configured to operate like amas.

Stage 4 illustrates a state when the front wheels (e.g., 214a, 214b) have been lowered to be about the same level as the rear wheels (e.g., 214c, 214d). In some implementations, the rear wheels may also be lowered. The lowering and raising of the front wheels and back wheels may be controlled by the controller 2300. In some implementations, Stage 3 and Stage 4 may illustrate examples of a transition configuration for the amphibious vehicle 200.

Stage 5, as shown in FIG. 19C, illustrates a state when the amphibious vehicle 200 is in shallow body of water 1910 such that the wheels (e.g., 214a, 214b, 214c, 214d) are touching the terrain 1900 or almost touching the terrain 1900. The hull positioning device 204 has further rotated the first hull section 220 and the second hull section 222 upwards.

Stage 6 illustrates a state when the amphibious vehicle 200 is in a land mode configuration. In this configuration, the first hull section 220 and the second hull section 222 are located over the wheels and the frame structure 206. The amphibious vehicle 200 is over the terrain 1900. The first propulsion device 208 may drive the wheels, which propels the amphibious vehicle 200 out of the body of water 1910 and onto the terrain 1900.

Exemplary Sequence of an Amphibious Vehicle Transitioning from a Land Mode Configuration to a Water Mode Configuration

FIG. 20 (which includes FIGS. 20A-20C) illustrates an exemplary sequence of an amphibious vehicle transitioning from a land mode configuration to a water mode configuration. In some implementations, the sequence of FIGS. 20A-20C illustrates the amphibious vehicle 200 of FIG. 2.

It is noted that the sequence of FIGS. 20A-20C may combine one or more stages in order to simplify and/or clarify the sequence shown in FIGS. 20A-20C. In some implementations, the order of the sequence of the operation may be changed or modified. Additional operations may also be added to the sequence.

Stage 1, as shown in FIG. 20A, illustrates a state when the amphibious vehicle 200 is in a land mode configuration. In this configuration, the first hull section 220 and the second hull section 222 are located over the wheels and the frame structure 206. The amphibious vehicle 200 is over the terrain 1900.

Stage 2 illustrates a state when the amphibious vehicle 200 has moved in a shallow body of water 1910. The wheels (e.g., 214a, 214a, 214c, 214d) may still be in contact with the terrain 1900 or almost the terrain 1900. The hull positioning device 204 has further rotated the first hull section 220 and the second hull section 222 towards the side of the frame structure 206.

Stage 3, as show in FIG. 20B, illustrates a state when the first hull section 220 and the second hull section 222 have been deployed to the point the first hull section 220 and the second hull section 222 are located completely lateral to the wheels (e.g., 214a, 214b, 214c, 214d). The first hull section 220 and the second hull section 222 may be configured to operate like amas.

Stage 4 illustrates a state when the front wheels (e.g., 214a, 214b) have been raised to be higher than the rear wheels (e.g., 214c, 214d). In some implementations, the rear wheels may also be raised. This may be done to create space for the hull sections to be placed underneath the wheels. The raising of the front wheels and back wheels may be controlled by the controller 2300. In some implementations, Stage 3 and Stage 4 may illustrate examples of a transition configuration for the amphibious vehicle 200.

Stage 5, as show in FIG. 20C, illustrates a state when the first hull section 220 and the second hull section 222 have been positioned to be underneath the wheels (e.g., 214a, 214b, 214c, 214d).

Stage 6 illustrates a state after the first hull section 220 has been coupled to the third hull section 224, and the second hull section 222 has been coupled to the third hull section 224 to form the hull 202. In the water mode configuration, the hull sections (e.g., first hull section 220, the second hull section 222, the third hull section 224) are coupled together and form a hull 202 that includes a continuous planing surface. In some implementations, the hull sections may be coupled and locked together through the hull positioning device 204 and/or the locking device 400. The front wheels (e.g., 214a, 214b) are raised. In this configuration, the amphibious vehicle 200 is propelled through the second propulsion device 210 (e.g., waterjet). In addition, the hull 202 provides buoyancy for the amphibious vehicle 200. In some implementations, the locking device 400 and/or the hull positioning device 204 may be operated and/or controlled by the controller 2300.

Exemplary Flow Diagram of a Method of Transitioning an Amphibious Vehicle from a Water Mode Configuration to a Land Mode Configuration

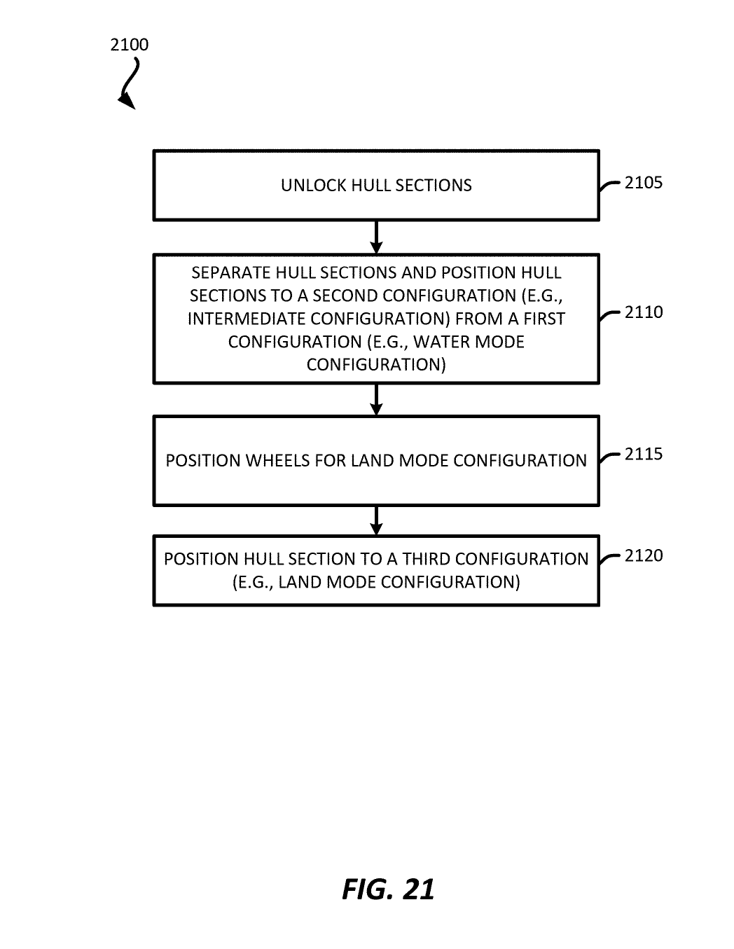

FIG. 21 illustrates an exemplary flow diagram of a method 2100 of transitioning of an amphibious vehicle from a water mode configuration to a land mode configuration. In some implementations, the method of FIG. 21 illustrates a method that is performed by the amphibious vehicle 200 of FIG. 2. In some implementations, the method 2100 may be performed by one or more controllers (e.g., 216, 2300) of the amphibious vehicle 200.

It is noted that the method of FIG. 21 may combine one or more stages in order to simplify and/or clarify the method shown in FIG. 21. In some implementations, the order of the method of the operation may be changed or modified. In some implementations, the method 2100 is performed when the amphibious vehicle 200 is in a water mode configuration. The method 2100 will be described with respect to FIGS. 19A-19C.

The method unlocks (at 2105) the hull sections from the hull 202. For example, the method may unlock one or more locking devices 400, which allows the hull sections (e.g., 220, 222, 224) to be separated from one another. Stage 1 of FIG. 19A may illustrate a configuration of the amphibious vehicle 200 before or after the hull sections have been unlocked from one another. At this stage, the hull sections have not been separated or uncoupled yet.

The method separates (at 2110) the hull sections and positions the hull sections to a second configuration (e.g., intermediate configuration). For example, the method may use the hull positioning device 204 to move and rotate the first hull section 220 and the second hull section 222. The rotary actuator 570 may rotate which causes the first rotation frame 510 and the second rotation frame 520 to rotate. Since the first rotation frame 510 is coupled to the first hull section 220 through the first mounting block 540, and the second rotation frame 520 is coupled to the second hull section 222 through the second mounting block 542, the first hull section 220 and the second hull section 222 would rotate and separate (e.g., decouple) from the third hull section 224. In some implementations, the first hull section 220 may rotate about the first rotation frame 520, and the second hull section 220 may rotate about the second rotation frame 522. The first hydraulic cylinder 530 may cause the first mounting block 540 to rotate, which causes the first hull section 220 to rotate about the first rotation frame 520. The second hydraulic cylinder 532 may cause the second mounting block 542 to rotate, which causes the second hull section 222 to rotate about the second rotation frame 522.

Stage 2 of FIG. 19A and Stage 3 of FIG. 19B may illustrate a configuration of the amphibious vehicle 200 after the hull sections (e.g., 220, 222) have been separated and rotated

The method positions (at 2115) one or more wheels (e.g., 214a, 214b, 214c, 214d) to prepare the amphibious vehicle 200 for a third configuration (e.g., land mode configuration). For example, the method may lower one or more wheels relative to the frame structure 206. Lowering the wheels may include rotation and/or translation of the wheels and components (e.g., suspension systems) coupled to the wheels. The positioning of the wheels may be done simultaneously or sequentially. In some implementations, lowering the wheels may include lowering the wheels partially and/or fully into the body of water. In some implementations, some or all of the wheels may already be in the body of water prior to the lowering of the wheels. In some implementations, the wheels (e.g., 214a, 214b, 214c, 214d) may help provide buoyancy for the amphibious vehicle 200. It is noted that not all the wheels need to be lowered. Different implementations may lower the wheels differently and/or at different heights.

Stage 4 of FIG. 19B illustrates the lowering of the wheels (e.g., 214a, 214b, 214c, 214d) of the amphibious vehicle 200.

The method positions (at 2120) the hull sections (e.g., 220, 222) such that the amphibious vehicle 200 is in a land mode configuration. In some implementations, the first hull section 220 and the second hull section 222 are positioned above the wheels (e.g., 214a, 214b, 214c, 214d) and/or the frame structure 206. In some implementations, the first rotation frame 510 and the second rotation frame 520 are rotated towards each other to raise the first hull section 220 and the second hull section 222. The first hull section 220 and the second hull section 222 may also be rotated about their respective first rotation frame 510 and second rotation frame 520.

Stages 5 and 6 of FIG. 19C illustrate the positioning of the first hull section 220 and the second hull section 222 over the wheels (e.g., 214a, 214b, 214c, 214d) and/or the frame structure 206 of the amphibious vehicle 200.

Exemplary Flow Diagram of a Method of Transitioning an Amphibious Vehicle from a Land Mode Configuration to a Water Mode Configuration

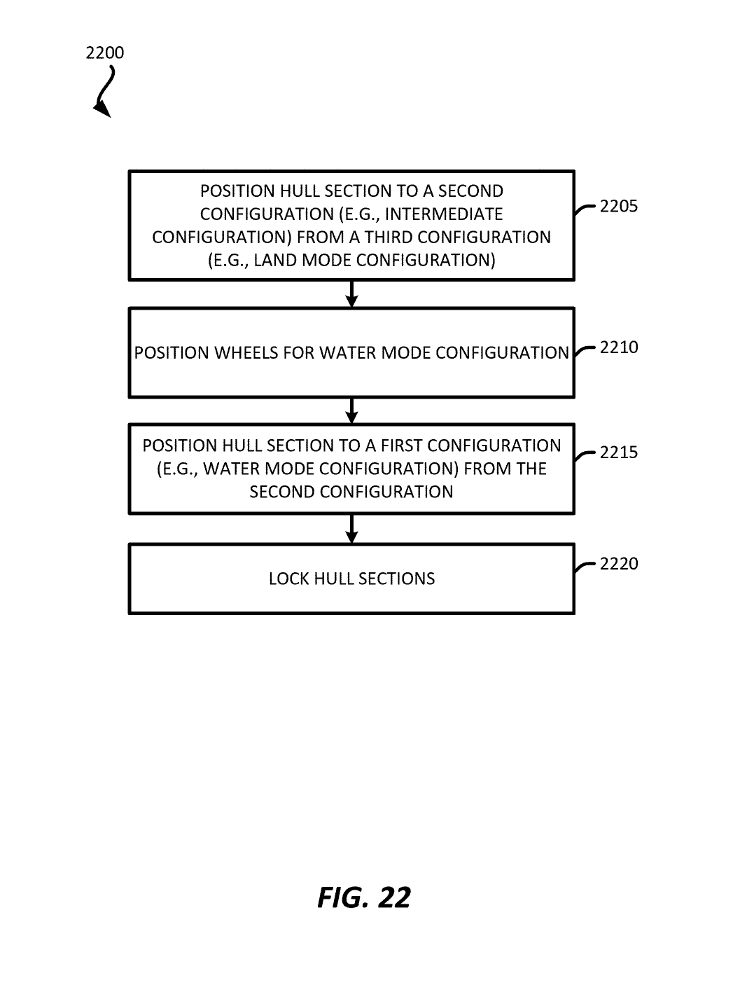

FIG. 22 illustrates an exemplary flow diagram of a method 2200 of transitioning of an amphibious vehicle from a land mode configuration to a water mode configuration. In some implementations, the method of FIG. 22 illustrates a method that is performed by the amphibious vehicle 200 of FIG. 2. In some implementations, the method 2200 may be performed by one or more controllers (e.g., 216, 2300) of the amphibious vehicle 200.

It is noted that the method of FIG. 22 may combine one or more stages in order to simplify and/or clarify the method shown in FIG. 22. In some implementations, the order of the method of the operation may be changed or modified. In some implementations, the method 2200 is performed when the amphibious vehicle 200 is in a land mode configuration. The method 2200 will be described with respect to FIGS. 20A-20C. Stage 1 of FIG. 20A may illustrate the amphibious vehicle 200 in the land mode configuration.

The method positions (at 2205) the hull sections (e.g., 220, 222) such that the amphibious vehicle 200 is in a transition configuration. In some implementations, the first hull section 220 and the second hull section 222 are positioned to the sides of the wheels (e.g., 214a, 214b, 214c, 214d) and/or the sides of the frame structure 206. In some implementations, the first rotation frame 510 and the second rotation frame 520 are rotated away from each other to lower the first hull section 220 and the second hull section 222. The first hull section 220 and the second hull section 222 may also be rotated about their respective first rotation frame 510 and second rotation frame 520. The amphibious vehicle 200 may be located in a body of water (e.g., shallow water) when positioning the hull sections to the side.

Stage 2 of FIG. 20A and Stage 3 of FIG. 20B illustrate the positioning of the first hull section 220 and the second hull section 222 towards the side of the wheels (e.g., 214a, 214b, 214c, 214d) and/or the side of the frame structure 206.

The method positions (at 2210) one or more wheels (e.g., 214a, 214b, 214c, 214d) to prepare the amphibious vehicle 200 for a first configuration (e.g., water mode configuration). For example, the method may raise one or more wheels relative to the frame structure 206. Raising the wheels may include rotation and/or translation of the wheels and components (e.g., suspension systems) coupled to the wheels. The positioning of the wheels may be done simultaneously or sequentially. In some implementations, raising the wheels may include raising the wheels partially and/or fully out of the body of water. In some implementations, some or all of the wheels may already be in the body of water or out of the body of water prior to the raising of the wheels. It is noted that not all the wheels need to be raised. Different implementations may raise the wheels differently and/or at different heights.

Stage 4 of FIG. 20B illustrates the raising of the wheels (e.g., 214a, 214b, 214c, 214d) of the amphibious vehicle 200.

The method couples (at 2215) the hull sections to form a first configuration (e.g., water mode configuration). For example, the method may use the hull positioning device 204 to move and rotate the first hull section 220 and the second hull section 222 towards each other. The rotary actuator 570 may rotate which causes the first rotation frame 510 and the second rotation frame 520 to rotate. Since the first rotation frame 510 is coupled to the first hull section 220 through the first mounting block 540, and the second rotation frame 520 is coupled to the second hull section 222 through the second mounting block 542, the first hull section 220 and the second hull section 222 would rotate and couple to the third hull section 224. In some implementations, the first hull section 220 may rotate about the first rotation frame 520, and the second hull section 220 may rotate about the second rotation frame 522. The first hydraulic cylinder 530 may cause the first mounting block 540 to rotate, which causes the first hull section 220 to rotate about the first rotation frame 520. The second hydraulic cylinder 532 may cause the second mounting block 542 to rotate, which causes the second hull section 222 to rotate about the second rotation frame 522.

Stages 5 and 6 of FIG. 20C may illustrate a configuration of the amphibious vehicle 200 after the hull sections (e.g., 220, 222) have been coupled to each other to form the hull 202 that includes a continuous planning surface. There may be water inside the hull 202. In some implementations, a pump may be used to remove the water inside the hull 202. In some implementations, there may be one or more holes in the amphibious vehicle 200 (e.g., inside the hull 202) that allows the water to leave the amphibious vehicle 200.

The method locks (at 2220) the hull sections together to form the hull 202. For example, the method may lock one or more locking devices 400, which allows the hull sections (e.g., 220, 222, 224) to form the hull 202 that includes a continuous planing surface. Stage 6 of FIG. 20C may illustrate a configuration of the amphibious vehicle 200 before or after the hull sections have been locked together.

Having described sequences and methods for transitioning an amphibious vehicle between different modes and/or configurations, a controller that is capable of performing and/or controlling the above methods will now be described below.

### Exemplary Controller for Amphibious Vehicle

FIG. 23 illustrates a conceptual illustration of the functionalities of a controller 2300 for the amphibious vehicle 200. The controller 2300 may be used to perform automated operations of the amphibious vehicle 200. In some implementations, there may be several controllers 2300 that may be located in different locations of the amphibious vehicle 200. In some implementations, the controller 2300 is a conceptual example of the controller 216 described in FIG. 2. The controller 2300 may be implemented as hardware (e.g., processor, die, integrated device), software (e.g., non-transitory processor readable medium), and/or combinations thereof, in one or more devices (e.g., processor, chip, computer, tablet, mobile device).

As shown in FIG. 23, the controller 2300 includes one or more processors 2302, one or more memory storage 2304, one or more hull positioning controllers 2310, one or more land propulsion controllers 2320, one or more water propulsion controllers 2330, one or more buoyancy controllers 2340, one or more sensors controllers 2350, one or more navigation controllers 2360, one or more other controllers 2370, one or more communications devices 2380, and/or one or more user interfaces 2390. In some implementations, the above functions may be implemented in one or more controllers, devices, dies and/or integrated devices.

The processor 2302, the memory storage 2304 and/or combinations thereof, may be configured to process or perform operations with the one or more hull positioning controllers 2310, one or more land propulsion controllers 2320, one or more water propulsion controllers 2330, one or more buoyancy controllers 2340, one or more sensors controllers 2350, one or more navigation controllers 2360, one or more other controllers 2370, one or more communications devices 2380, and/or one or more user interfaces 2390. The one or more hull positioning controllers 2310 are configured to control the operation of the hull positioning device 204. The one or more land propulsion controllers 2320 are configured to control the operation of the first propulsion device 208 (e.g., motor, engine) and/or the transfer case 620. The one or more water propulsion controllers 2330 are configured to control the operation of the first propulsion device 208 (e.g., motor, engine), the transfer case 620 and/or the second propulsion device 210 (e.g., waterjet). In some implementations, the land propulsion controllers 2320 and the water propulsion controllers 2330 may be part of one or more propulsion controllers. The one or more buoyancy controllers 2340 are configured to control the operation of the buoyancy device 212. The one or more sensors controllers 2350 are configured to control the operation of one or more sensors. In some implementations, controlling the operation of a sensor may include receiving readings and/or measurements from the sensor. The one or more navigation controllers 2360 are configured to control the operation of a navigation device and/or mechanism for the amphibious device 200. In some implementations, the one or more navigation controllers 2360 may provide autonomous functionality for the amphibious vehicle 200. The one or more navigation controllers 2360 may control steering of the wheels of the amphibious vehicle 200 and/or steering of the second propulsion device 210. Thus, for example, the one or more navigation controllers 2360 may be part of a land and in-water steering mechanism for the amphibious vehicle 200 that can steer the wheels and the second propulsion device 210 simultaneously. The one or more navigation controllers 2360 may communicate with Global Positioning Systems (GPS) and/or radars (e.g., Lidar) to navigate the amphibious vehicle 200. Other controllers 2370 may be configured to control the operation of other devices for the amphibious vehicle 200. For example, the locking device 400 may be controlled by the other controllers 2370. In some implementations, the locking device 400 may be controlled by the hull positioning controllers 2310. The communication devices 2380 may include different devices and/or interfaces to communicate with different devices (e.g., sensors) and/or components. The communication devices 2380 may include a bus interface, a wired interface, wireless interface (e.g., Wireless Fidelity (WIFI), Bluetooth, radio, cellular, etc. . . . ), and/or an optical interface.

The user interfaces 2390 allow an operator to control and monitor the operation of the amphibious vehicle 200 locally and/or remotely. For example, the user interfaces 2390 may allow an operator to remotely control the amphibious vehicle 200. The user interfaces 2390 may also allow an operator to remotely control devices (e.g., sensor, camera, antenna, weapons) coupled to the amphibious vehicle 200. However, it is noted that the amphibious vehicle 200 may operate autonomously.

One or more of the components, processes, features, and/or functions illustrated in FIGS. 2-18, 19A-19C, 20A-20C and/or 21-23 may be rearranged and/or combined into a single component, process, feature or function or embodied in several components, processes, or functions. Additional devices, elements, components, processes, and/or functions may also be added without departing from the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. It is noted that the term “grabbing” an object shall include encircling an object. Thus, grabbing an object does not necessarily mean physically touching the object.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be rearranged. A process is terminated when its operations are completed. A process may correspond to a method, a function, a procedure, a subroutine, a subprogram, etc. When a process corresponds to a function, its termination corresponds to a return of the function to the calling function or the main function. Any of the above methods and/or processes may also be code that is stored in a computer/processor readable storage medium that can be executed by at least one processing circuit, processor, die and/or controller. For example, the controller may include one or more processing circuits that may execute code stored in a computer/processor readable storage medium. A computer/processor readable storage medium may include a memory (e.g., memory die, memory in a logic die, memory controller). A die may be implemented as a flip chip, a wafer level package (WLP), and/or a chip scale package (CSP).

Those of skill in the art would further appreciate that the various illustrative logical blocks, modules, circuits, and algorithm steps described in connection with the embodiments disclosed herein may be implemented as electronic hardware, computer software, and/or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the disclosure described herein can be implemented in different devices and/or systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

1. An amphibious vehicle comprising:
a hull comprising a plurality of hull sections;
a hull positioning device configured to position one of more hull sections from the plurality of hull sections into a plurality of positions;
a first propulsion device configured to propel the amphibious vehicle when the amphibious vehicle is on land;
a second propulsion device configured to propel the amphibious vehicle when the amphibious vehicle is in a body of water; and
a buoyancy device configured to provide buoyancy for the amphibious vehicle when the amphibious vehicle is in the body of water.

2. The amphibious vehicle of claim 1, wherein the hull comprising the plurality of hull sections includes a continuous planing surface.

3. The amphibious vehicle of claim 1, further comprising a plurality of wheels coupled to the first propulsion device, wherein the first propulsion device is configured to power the plurality of wheels and power the second propulsion device.

4. The amphibious vehicle of claim 3, wherein the first propulsion device is configured to power the plurality of wheels and power the second propulsion device simultaneously.

5. The amphibious vehicle of claim 4, wherein the second propulsion device comprises a waterjet.

6. The amphibious vehicle of claim 5, wherein the first propulsion device comprises a motor.

7. The amphibious vehicle of claim 1, wherein the plurality of hull sections comprises:
a first hull section;
a second hull section; and
a third hull section,
wherein the first hull section and the second hull sections are configurable to be coupled to the third hull section.

8. The amphibious vehicle of claim 7, further comprising:
a first locking device configured to lock the first hull section to the third hull section; and
a second locking device configured to lock the second hull section to the third hull section.

9. The amphibious vehicle of claim 7, further comprising a frame structure coupled to the third hull section, wherein the third hull section is fixed to the frame structure.

10. The amphibious vehicle of claim 7, further comprising:
a first seal layer configured to seal a seam between the first hull section and the third hull section; and
a second seal layer configured to seal a seam between the second hull section and the third hull section.

11. The amphibious vehicle of claim 1, wherein the plurality of hull sections comprises:
a first hull section; and
a second hull section configured to be coupled to the first hull.

12. The amphibious vehicle of claim 1, further comprising a frame structure coupled to the buoyancy device.

13. The amphibious vehicle of claim 1, wherein in the buoyancy device includes an enclosed volume, a flexible membrane, an inflatable membrane, and/or a rigid volume.

14. The amphibious vehicle of claim 1, wherein the hull positioning device is configured to rotate the plurality of hull sections along a plurality of axis.

15. The amphibious vehicle of claim 1, wherein the hull positioning device is configured to rotate the first hull section along a first rotation axis and a second rotation axis.

16. The amphibious vehicle of claim 15, wherein the rotation of the first hull section is driven by a linear actuator.

17. The amphibious vehicle of claim 15, wherein the rotation of the first hull section is driven by a rotary actuator.

18. The amphibious vehicle of claim 15, wherein the hull positioning device is configured to translate the first hull section.

19. The amphibious vehicle of claim 15, wherein the hull positioning device comprises:
a rotary actuator;
a first rotation frame;
a plurality of first hinge mounts coupled to the first rotation frame;
a second rotation frame;
a plurality of second hinge mounts coupled to the second rotation frame;
a first mounting block coupled to the first rotation frame;
a second mounting block coupled to the second rotation frame;
a first hydraulic cylinder coupled to the first rotation frame and the first mounting block; and
a second hydraulic cylinder coupled to the second rotation frame and the second mounting block.

20. The amphibious vehicle of claim 1, further comprising a land and in-water steering mechanism.
